(19) United States
(12) Patent Application Publication
(10) Pub. No.: US 2026/0197079 A1
(43) Pub. Date: Jul. 9, 2026

(54) OPTICAL COMMUNICATION DEVICE AND OPTICAL COMMUNICATION SYSTEM

(71) Applicant: Japan Display Inc., Tokyo (JP)

(72) Inventor: Hitoshi SAITO, Tokyo (JP)

(21) Appl. No.: 19/550,949

(22) Filed: Feb. 26, 2026

Related U.S. Application Data
(63) Continuation of application No. PCT/JP2024/023513, filed on Jun. 28, 2024.

(30) Foreign Application Priority Data
Sep. 1, 2023 (JP) 2023-142344

(51) Int. Cl. H04B 10/112; G02F 1/1347

(52) U.S. Cl. CPC H04B 10/112; G02F 1/1347

(57) ABSTRACT

According to an aspect, an optical communication device includes: a light source; an optical element provided on an optical axis of the light source and configured to control a light distribution state of light emitted from the light source; and a processing circuit configured to perform light distribution control of the optical element. The processing circuit is configured to generate a character information code obtained by converting character information into Morse code, control the light distribution state of the optical element to a first light distribution shape when transmitting a short dot code of the character information code, and control the light distribution state of the optical element to a second light distribution shape different from the first light distribution shape when transmitting a long dot code of the character information code.

### CROSS-REFERENCE TO RELATED APPLICATION

This application claims the benefit of priority from Japanese Patent Application No. 2023-142344 filed on September 1, 2023 and International Patent Application No. PCT/JP2024/023513 filed on June 28, 2024, the entire contents of which are incorporated herein by reference.

### BACKGROUND

### 1. Technical Field

What is disclosed herein relates to an optical communication device and an optical communication system.

### 2. Description of the Related Art

Conventionally, a communication method using Morse code has been established. For example, a technology has been disclosed in which Morse-encoded information is transmitted by controlling a blinking pattern of a light emitter (for example, Japanese Patent Application Laid-open Publication No. 2007-174509).

Morse code is a character code that is variable-length encoded by combining a short dot code ("·") and a long dot code ("-"), and is typically transmitted as a Morse signal subjected to pulse width modulation (PWM). Thus, a transmission time potentially becomes long, depending on the amount of information of encoded character strings, sentences, or the like.

For the foregoing reasons, there is a need for an optical communication device and an optical communication system that can shorten the transmission time of Morse-encoded information.

### SUMMARY

According to an aspect, an optical communication device includes: a light source; an optical element provided on an optical axis of the light source and configured to control a light distribution state of light emitted from the light source; and a processing circuit configured to perform light distribution control of the optical element. The processing circuit is configured to generate a character information code obtained by converting character information into Morse code, control the light distribution state of the optical element to a first light distribution shape when transmitting a short dot code of the character information code, and control the light distribution state of the optical element to a second light distribution shape different from the first light distribution shape when transmitting a long dot code of the character information code.

According to an aspect, an optical communication system includes an optical communication device, and a control device configured to transmit character information to the optical communication device. The optical communication device includes a light source, an optical element provided on an optical axis of the light source and configured to control a light distribution state of light emitted from the light source, and a processing circuit configured to perform light distribution control of the optical element. The processing circuit is configured to generate a character information code obtained by converting character information into Morse code, control the light distribution state of the optical element to a first light distribution shape when transmitting a short dot code of the character information code, and control the light distribution state of the optical element to a second light distribution shape different from the first light distribution shape when transmitting a long dot code of the character information code.

### BRIEF DESCRIPTION OF THE DRAWINGS

FIG. 1A is a side view illustrating an example of an optical communication device according to an embodiment;

FIG. 1B is a perspective view illustrating an example of an optical element according to the embodiment;

FIG. 2 is a schematic plan view of a first substrate when viewed in a Dz direction;

FIG. 3 is a schematic plan view of a second substrate when viewed in the Dz direction;

FIG. 4 is a see-through diagram of a liquid crystal cell in which the first substrate and the second substrate are stacked in the Dz direction;

FIG. 5 is a sectional view along line A-A' illustrated in FIG. 4;

FIG. 6A is a diagram illustrating the alignment direction of an alignment film of the first substrate;

FIG. 6B is a diagram illustrating the alignment direction of an alignment film of the second substrate;

FIG. 7 is a multilayered structure diagram of the optical element according to the embodiment;

FIG. 8A is a conceptual diagram for description of changes in shape of light by the optical element according to the embodiment;

FIG. 8B is a conceptual diagram for description of changes in shape of light by the optical element according to the embodiment;

FIG. 8C is a conceptual diagram for description of changes in shape of light by the optical element according to the embodiment;

FIG. 8D is a conceptual diagram for description of changes in shape of light by the optical element according to the embodiment;

FIG. 9 is a conceptual diagram for conceptually describing light distribution control by the optical communication device according to the embodiment;

FIG. 10 is a diagram illustrating a schematic configuration of an optical communication system according to a first embodiment;

FIG. 11 is a block diagram illustrating an example of a control device according to the first embodiment;

FIG. 12 is a block diagram illustrating an example of the optical communication device according to the first embodiment;

FIG. 13A is a diagram illustrating a specific example of a first light distribution shape;

FIG. 13B is a diagram illustrating a specific example of a second light distribution shape;

FIG. 14 is a flowchart illustrating an example of information transmission processing in the optical communication system according to the first embodiment;

FIG. 15 is a diagram illustrating a schematic configuration of an optical communication system according to a second embodiment;

FIG. 16 is a block diagram illustrating an example of a reception device according to the second embodiment;

FIG. 17 is a flowchart illustrating an example of information transmission processing in the optical communication system according to the second embodiment;

FIG. 18 is a diagram illustrating an example of header information;

FIG. 19 is a sub flowchart illustrating an example of header information transmission processing;

FIG. 20A is a conceptual table for describing light distribution control timing in the header information transmission processing;

FIG. 20B is a conceptual table for describing light distribution control timing in the header information transmission processing;

FIG. 20C is a conceptual table for describing light distribution control timing in the header information transmission processing;

FIG. 21 is a sub flowchart illustrating an example of message transmission processing;

FIG. 22A is a conceptual diagram for describing light distribution control timing in the message transmission processing;

FIG. 22B is a conceptual diagram for describing light distribution control timing in the message transmission processing;

FIG. 22C is a conceptual diagram for describing light distribution control timing in the message transmission processing;

FIG. 23 is a flowchart illustrating an example of information reception processing in the reception device;

FIG. 24 is a sub flowchart illustrating an example of header information reception processing; and

FIG. 25 is a sub flowchart illustrating an example of message reception processing.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate. What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

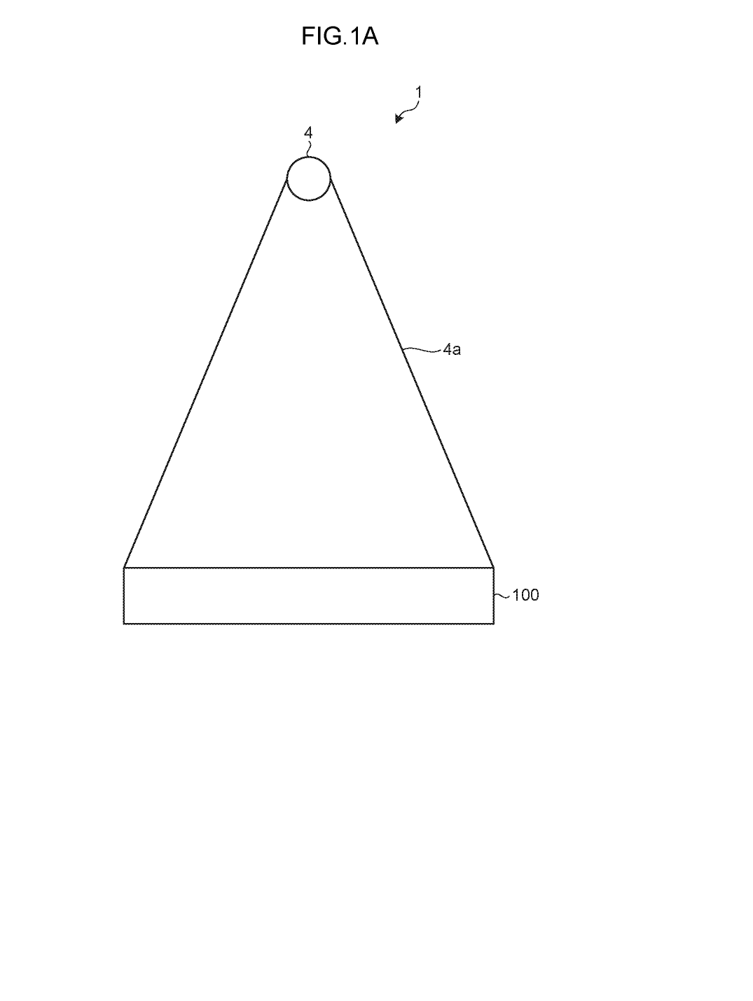

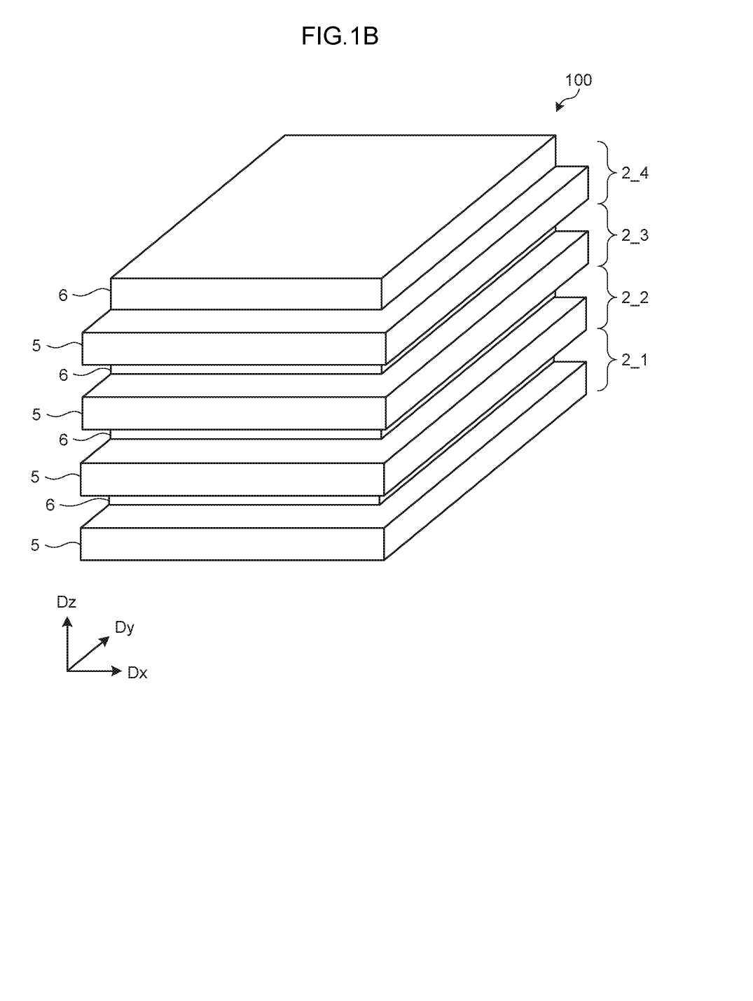

FIG. 1A is a side view illustrating an example of an optical communication device according to an embodiment. FIG. 1B is a perspective view illustrating an example of an optical element according to the embodiment. As illustrated in FIG. 1A, an optical communication device 1 includes a light source 4, a reflector 4a, and an optical element 100. As illustrated in FIG. 1B, the optical element 100 includes a first liquid crystal cell 2_1, a second liquid crystal cell 2_2, a third liquid crystal cell 2_3, and a fourth liquid crystal cell 2_4. The light source 4 is configured with, for example, a light emitting diode (LED). The reflector 4a is a component that condenses light from the light source 4 to the optical element 100.

In FIG. 1B, a Dz direction indicates the emission direction of light from the light source 4 and the reflector 4a. The optical element 100 has a configuration in which the first liquid crystal cell 2_1, the second liquid crystal cell 2_2, the third liquid crystal cell 2_3, and the fourth liquid crystal cell 2_4 are stacked in the Dz direction. In the present disclosure, the optical element 100 has a configuration in which the first liquid crystal cell 2_1, the second liquid crystal cell 2_2, the third liquid crystal cell 2_3, and the fourth liquid crystal cell 2_4 are sequentially stacked from the light source 4 side (lower side in FIG. 1B). In FIG. 1B, one direction in a plane orthogonal to the Dz direction and parallel to stacking surfaces of the first liquid crystal cell 2_1, the second liquid crystal cell 2_2, the third liquid crystal cell 2_3, and the fourth liquid crystal cell 2_4 is defined as a Dx direction (first direction), and a direction orthogonal to both the Dx direction and the Dz direction is defined as a Dy direction (second direction).

The first liquid crystal cell 2_1, the second liquid crystal cell 2_2, the third liquid crystal cell 2_3, and the fourth liquid crystal cell 2_4 have the same configuration. In the present disclosure, the first liquid crystal cell 2_1 and the fourth liquid crystal cell 2_4 are liquid crystal cells for p-wave polarization. The second liquid crystal cell 2_2 and the third liquid crystal cell 2_3 are liquid crystal cells for s-wave polarization. Hereinafter, the first liquid crystal cell 2_1, the second liquid crystal cell 2_2, the third liquid crystal cell 2_3, and the fourth liquid crystal cell 2_4 are also collectively referred to as "liquid crystal cells 2".

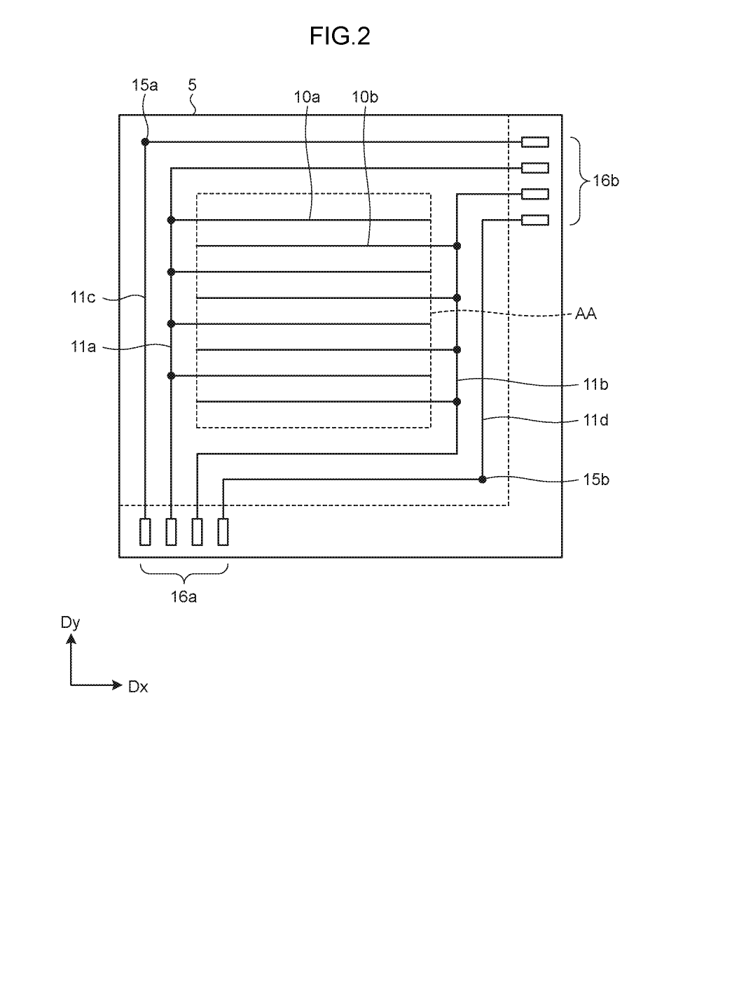

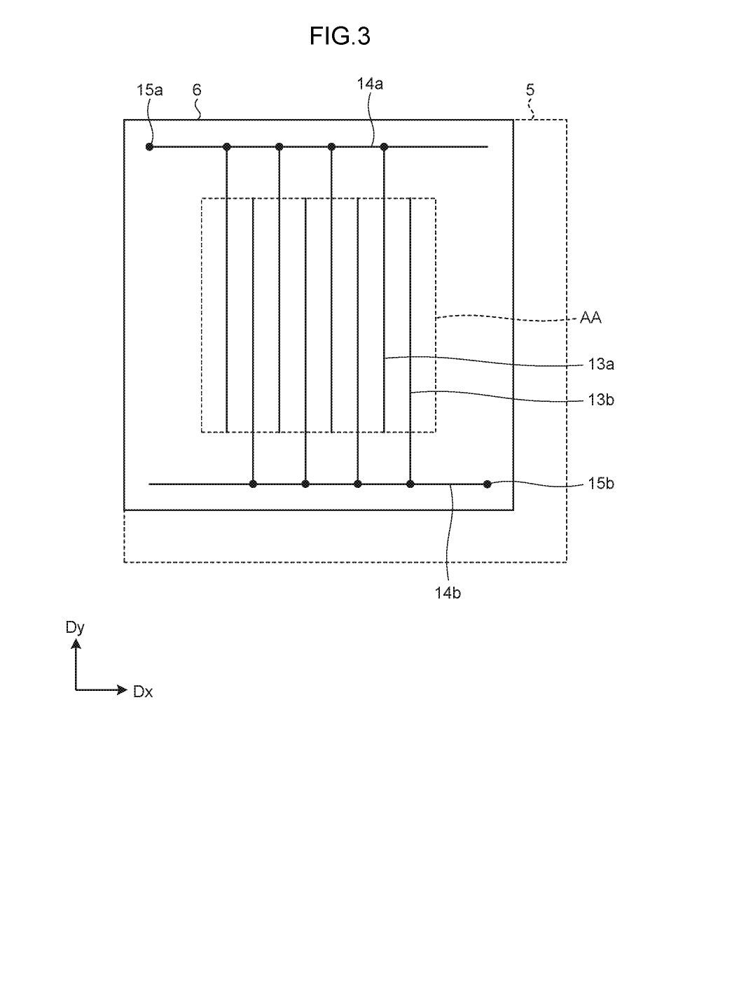

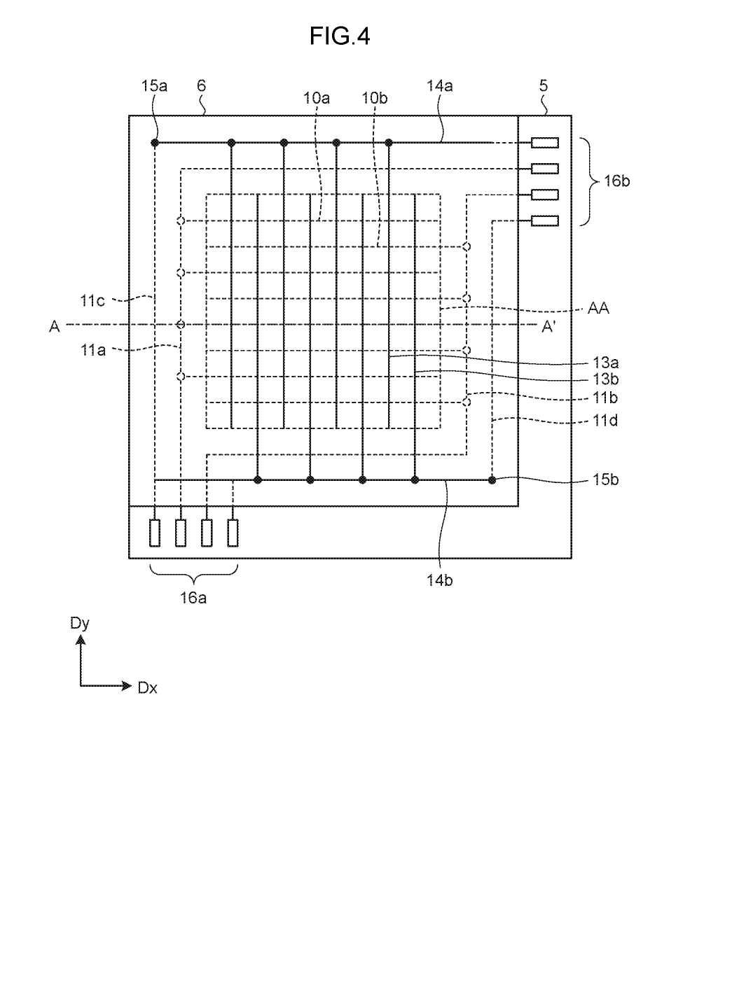

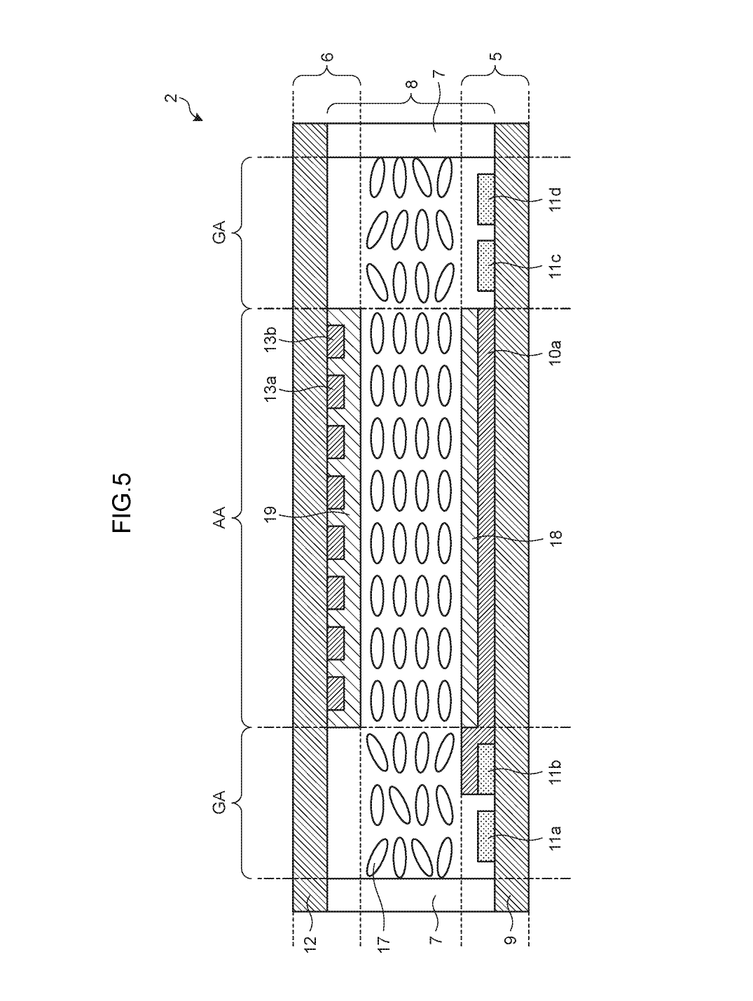

Each liquid crystal cell 2 includes a first substrate 5 and a second substrate 6. FIG. 2 is a schematic plan view of the first substrate when viewed in the Dz direction. FIG. 3 is a schematic plan view of the second substrate when viewed in the Dz direction. In FIG. 3, drive electrodes are visible through the substrates, but for clarity, the drive electrodes and wiring lines are illustrated with solid lines. FIG. 4 is a see-through diagram of a liquid crystal cell in which the first substrate and the second substrate are stacked in the Dz direction. In FIG. 4 as well, for clarity, the drive electrodes and wiring lines on the second substrate side are illustrated with solid lines, and the drive electrodes and wiring lines on the first substrate side are illustrated with dotted lines. FIG. 5 is a sectional view along line A-A' illustrated in FIG. 4. FIGS. 2, 3, 4, and 5, exemplarily illustrate the third liquid crystal cell 2_3 and the fourth liquid crystal cell 2_4 in which drive electrodes 10a and 10b of the first substrate 5 extend in the Dx direction and drive electrodes 13a and 13b of the second substrate 6 extend in the Dy direction.

As illustrated in FIG. 5, the liquid crystal cell 2 includes a liquid crystal layer 8 sealed around its periphery by a sealing member 7 between the first substrate 5 and the second substrate 6.

The liquid crystal layer 8 modulates light passing through the liquid crystal layer 8 in accordance with the state of electric field. As liquid crystal molecules, positive-type nematic liquid crystals are used, but other liquid crystals with the same effects may be used.

As illustrated in FIG. 2, the drive electrodes 10a and 10b, metal lines 11a and 11b, and metal lines 11c and 11d are provided on the liquid crystal layer 8 side of a base member 9 of the first substrate 5. The metal lines 11a and 11b supply drive voltage that is applied to the drive electrodes 10a and 10b, and the metal lines 11c and 11d supply drive voltage that is applied to the drive electrodes 13a and 13b (refer to FIG. 3) provided on the second substrate 6 to be described later The metal lines 11a, 11b, 11c, and 11d are provided in a wiring layer of the first substrate 5. The metal lines 11a, 11b, 11c, and 11d are provided to be spaced apart in the wiring layer on the first substrate 5. Hereinafter, the drive electrodes 10a and 10b are simply referred to as "drive electrodes 10" in some cases. The metal lines 11a, 11b, 11c, and 11d are referred to as "first metal lines 11" in some cases. As illustrated in FIG. 2, in the third liquid crystal cell 2_3 and the fourth liquid crystal cell 2_4, the drive electrodes 10 on the first substrate 5 extend in the Dx direction. In the first liquid crystal cell 2_1 and the second liquid crystal cell 2_2, the drive electrodes 10 on the first substrate 5 extend in the Dy direction.

As illustrated in FIG. 3, the drive electrodes 13a and 13b, and metal lines 14a and 14b are provided on the liquid crystal layer 8 side of a base member 12 of the second substrate 6 illustrated in FIG. 5. The metal lines 14a and 14b are provided in a wiring layer of the second substrate 6 and supply drive voltage that is applied to the drive electrodes 13. The metal lines 14a and 14b are provided to be spaced apart in the wiring layer on the second substrate 6. Hereinafter, the drive electrodes 13a and 13b are simply referred to as "drive electrodes 13" in some cases. The metal lines 14a and 14b are referred to as "second metal lines 14" in some cases. As illustrated in FIG. 3, in the third liquid crystal cell 2_3 and the fourth liquid crystal cell 2_4, the drive electrodes 13 on the second substrate 6 extend in the Dy direction. In the first liquid crystal cell 2_1 and the second liquid crystal cell 2_2, the drive electrodes 13 on the second substrate 6 extend in the Dx direction.

The drive electrodes 10 and 13 are light-transmitting electrodes formed of a light-transmitting conductive material (light-transmitting conductive oxide) such as indium tin oxide (ITO). The first substrate 5 and the second substrate 6 are light-transmitting substrates of glass, resin, or the like. The first metal lines 11 and the second metal lines 14 are formed of at least one metallic material among aluminum (Al), copper (Cu), silver (Ag), molybdenum (Mo), and alloy thereof. The first metal lines 11 and the second metal lines 14 may be each formed of one or more of these metallic materials as a multilayered body of a plurality of layers. The at least one metallic material among aluminum (Al), copper (Cu), silver (Ag), molybdenum (Mo), and alloy thereof has a resistance lower than that of light-transmitting conductive oxide such as ITO.

The metal line 11c of the first substrate 5 and the metal line 14a of the second substrate 6 are coupled by a conduction part 15a made of, for example, conductive paste. The metal line 11d of the first substrate 5 and the metal line 14b of the second substrate 6 are coupled by a conduction part 15b made of, for example, conductive paste.

Coupling (flex-on-board) terminal parts 16a and 16b that are coupled to non-illustrated flexible printed circuits (FPC) are provided in regions on the first substrate 5, which do not overlap the second substrate 6 when viewed in the Dz direction. The coupling terminal parts 16a and 16b each include four coupling terminals corresponding to the metal lines 11a, 11b, 11c, and 11d, respectively.

The coupling terminal parts 16a and 16b are provided in the wiring layer of the first substrate 5. Drive voltage to be applied to the drive electrodes 10a and 10b on the first substrate 5 and to the drive electrodes 13a and 13b on the second substrate 6 is supplied to the liquid crystal cell 2 from an FPC coupled to the coupling terminal part 16a or the coupling terminal part 16b. Hereinafter, the coupling terminal parts 16a and 16b are simply referred to as "coupling terminal parts 16" in some cases.

As illustrated in FIG. 4, in the liquid crystal cell 2, the first substrate 5 and the second substrate 6 are arranged in the Dz direction (irradiation direction of light), and the drive electrodes 10 on the first substrate 5 intersect the drive electrodes 13 on the second substrate 6 when viewed in the Dz direction. In the liquid crystal cell 2 thus configured, the alignment direction of liquid crystal molecules 17 in the liquid crystal layer 8 can be controlled by supplying drive voltage to the drive electrodes 10 on the first substrate 5 and the drive electrodes 13 on the second substrate 6. A region in which the alignment direction of the liquid crystal molecules 17 in the liquid crystal layer 8 can be controlled is referred to as an "effective region AA". The refractive index distribution of the liquid crystal layer 8 is changed in the effective region AA, whereby the diffusion degree of light transmitted through the effective region AA of the liquid crystal cell 2 can be controlled. A region outside the effective region AA, where the liquid crystal layer 8 is sealed by the sealing member 7, is referred to as a "peripheral region GA" (refer to FIG. 5).

As illustrated in FIG. 5, the drive electrodes 10 (in FIG. 5, the drive electrode 10a) in the effective region AA of the first substrate 5 are covered by an alignment film 18. The drive electrodes 13 (in FIG. 5, the drive electrodes 13a and 13b) in the effective region AA of the second substrate 6 are covered by an alignment film 19. The alignment direction of the liquid crystal molecules is different between the alignment film 18 and the alignment film 19.

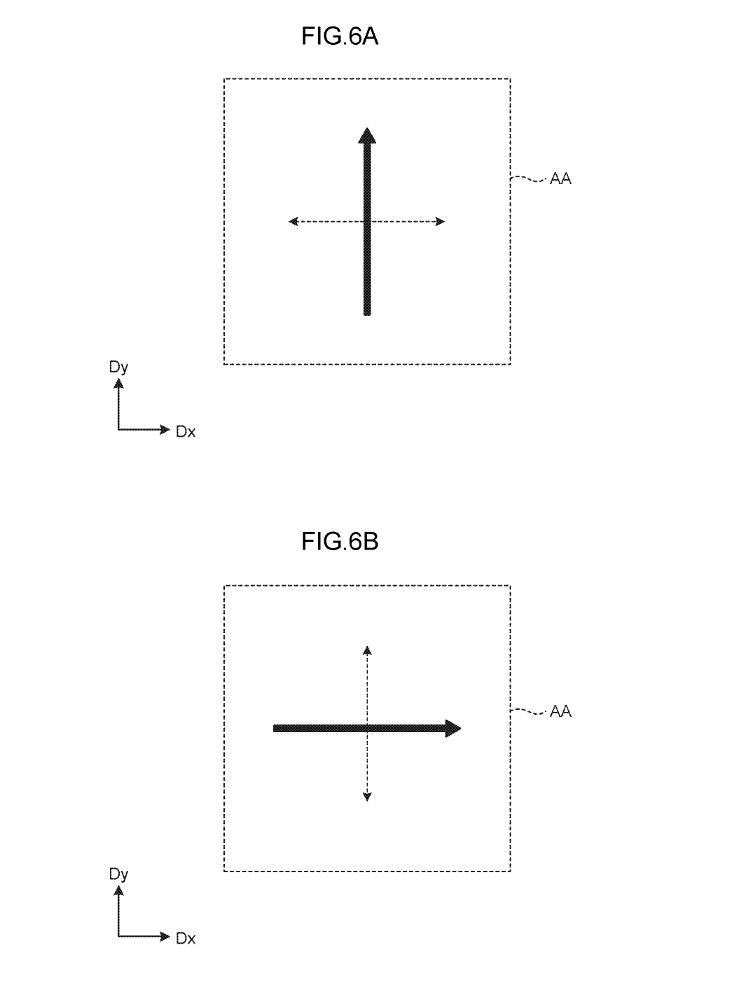

FIG. 6A is a diagram illustrating the alignment direction of the alignment film of the first substrate. FIG. 6B is a diagram illustrating the alignment direction of the alignment film of the second substrate.

As illustrated in FIGS. 6A and 6B, the alignment direction of the alignment film 18 of the first substrate 5 and the alignment direction of the alignment film 19 of the second substrate 6 are directions intersecting each other in plan view. Specifically, as illustrated with a solid arrow in FIG. 6A, the alignment direction of the alignment film 18 of the first substrate 5 is orthogonal to the extending direction of the drive electrodes 10a and 10b, which is illustrated with a dashed arrow in FIG. 6A. As illustrated with a solid arrow in FIG. 6B, the alignment direction of the alignment film 19 of the second substrate 6 is orthogonal to the extending direction of the drive electrodes 13a and 13b, which is illustrated with a dashed arrow in FIG. 6B. In the following description, the extending directions of the drive electrodes 10 and 13 are orthogonal to the alignment directions of the alignment films 18 and 19 covering them, but these may intersect at an angle other than being orthogonal, for example, in the angle range of 85° to 90°. The drive electrodes 10 on the first substrate 5 side and the drive electrodes 13 on the second substrate 6 side are preferably orthogonal to each other but may intersect, for example, in the angle range of 85° to 90°. The alignment directions of the alignment films 18 and 19 are formed by rubbing processing or light alignment processing.

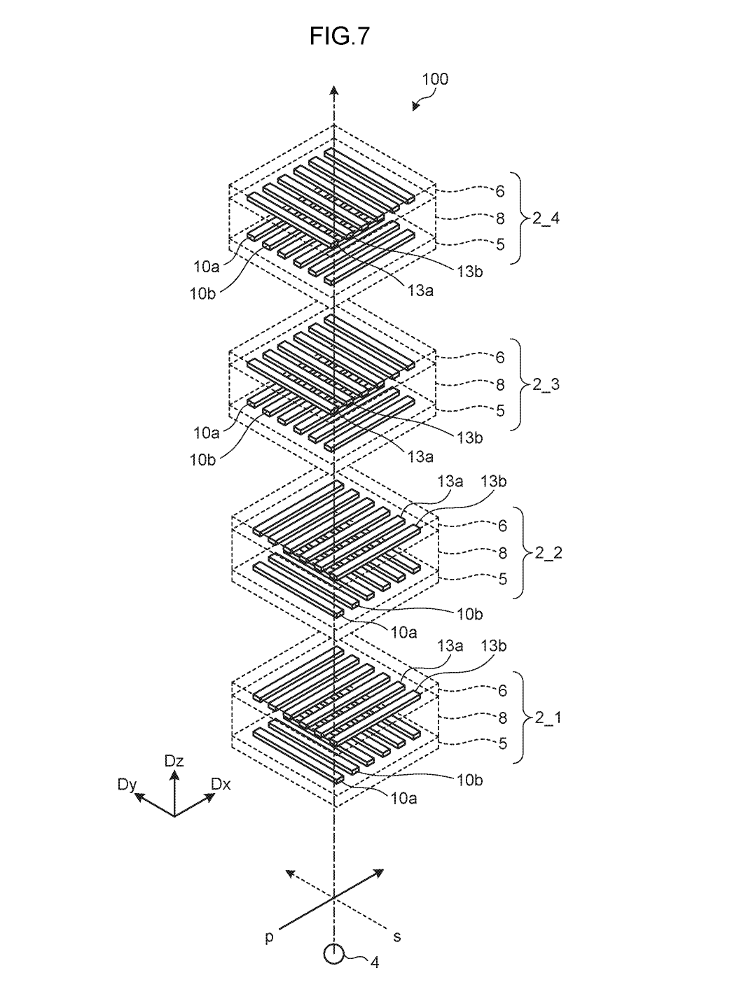

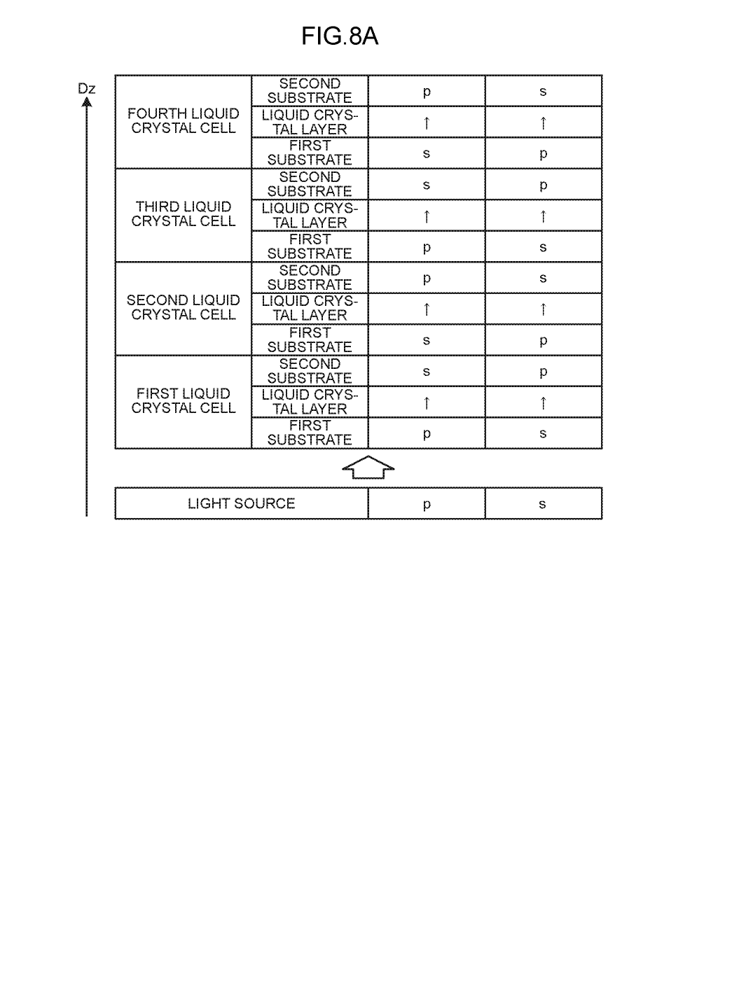

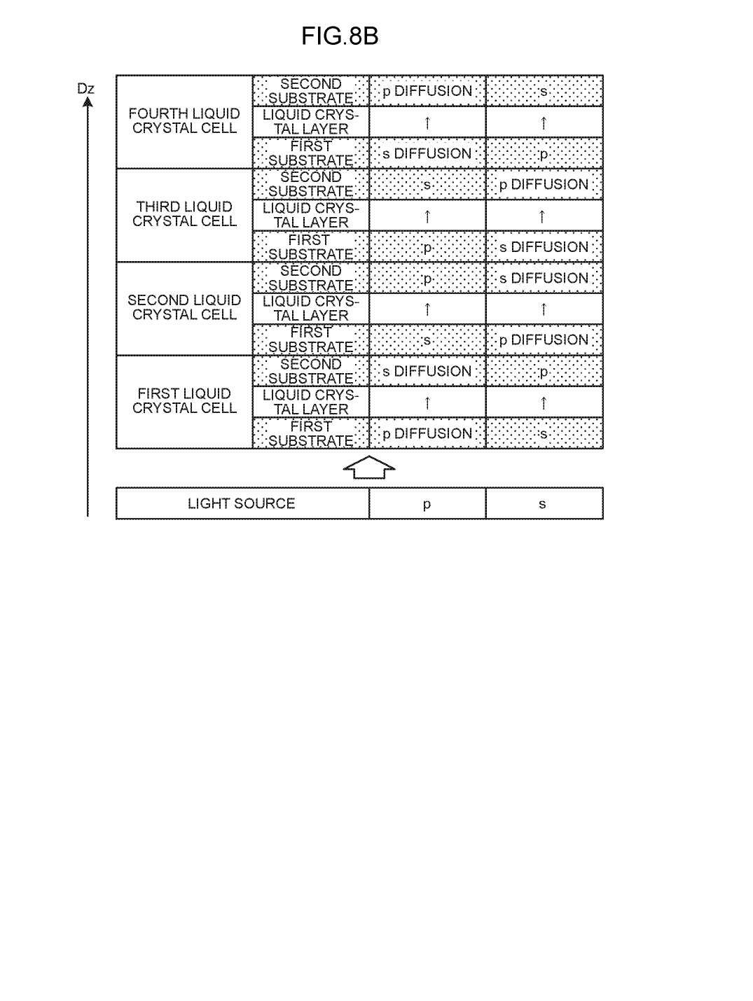

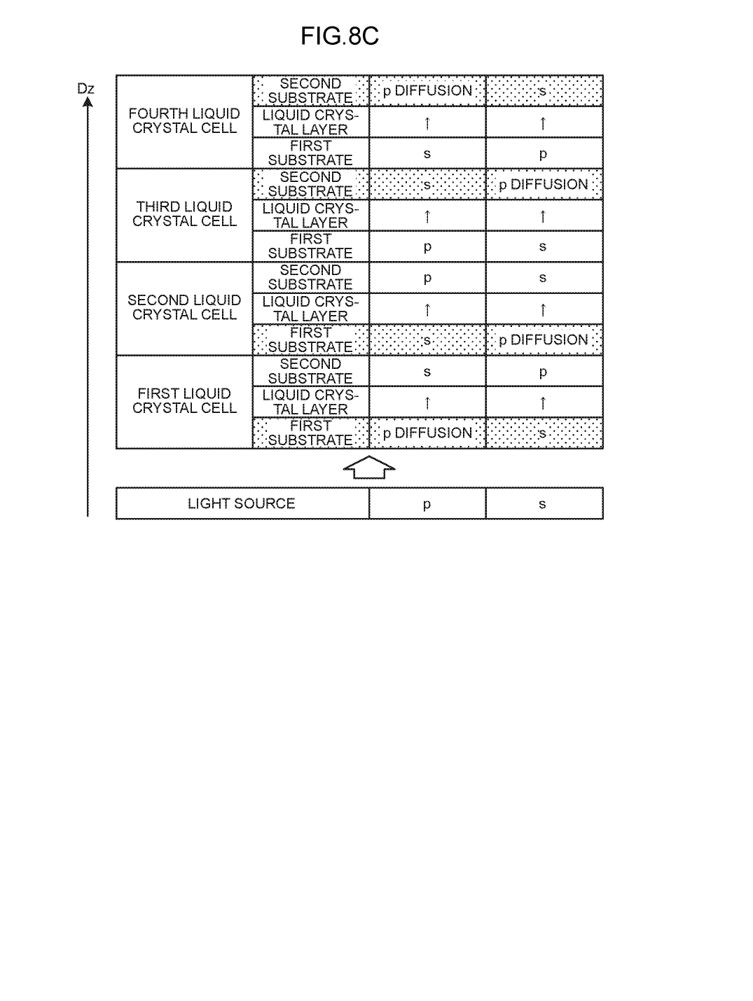

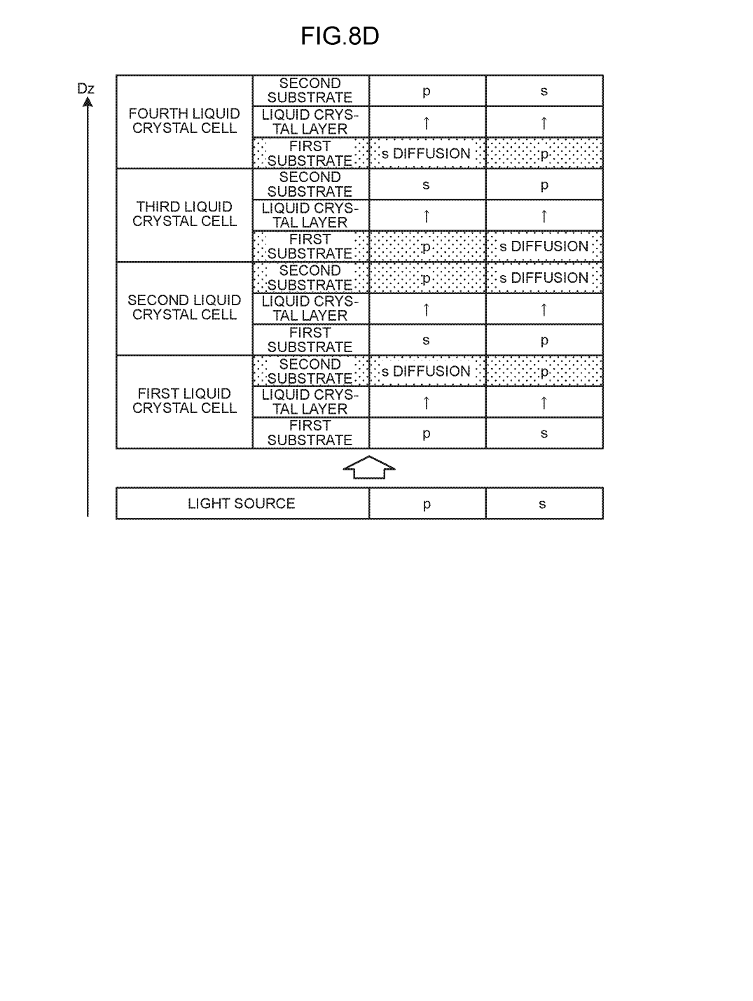

A mechanism for changing the shape of light by using the liquid crystal cells 2 (the first liquid crystal cell 2_1, the second liquid crystal cell 2_2, the third liquid crystal cell 2_3, and the fourth liquid crystal cell 2_4) will be described below. FIG. 7 is a multilayered structure diagram of the optical element according to the embodiment. FIGS. 8A, 8B, 8C, and 8D are conceptual diagrams for describing changes in shape of light by the optical element according to the embodiment. FIGS. 8A, 8B, 8C, and 8D illustrate examples in which potential difference is generated between the drive electrodes of hatched substrates of the liquid crystal cells 2.

As illustrated in FIG. 7, the optical element 100 is provided on the optical axis of the light source 4, which is illustrated with a dashed and single-dotted line, and as described above, the first liquid crystal cell 2_1, the second liquid crystal cell 2_2, the third liquid crystal cell 2_3, and the fourth liquid crystal cell 2_4 are sequentially stacked from the light source 4 side (lower side in FIG. 7). The third liquid crystal cell 2_3 and the fourth liquid crystal cell 2_4 are stacked in a state of being rotated by 90° relative to the first liquid crystal cell 2_1 and the second liquid crystal cell 2_2.

In each liquid crystal cell 2, the alignment direction of the alignment film on the first substrate 5 side and the second substrate 6 side intersect each other as illustrated in FIGS. 6A and 6B. Accordingly, from the first substrate 5 side toward the second substrate 6 side, the orientation of the liquid crystal molecules in the liquid crystal layer 8 gradually changes from the Dx direction to the Dy direction (or from the Dy direction to the Dx direction), and the polarized component of transmitted light rotates along with the change. Specifically, in the liquid crystal cell 2, the polarized component, which is a p-polarized component on the first substrate 5 side, changes to an s-polarized component as distance from the second substrate 6 decreases; and the polarized component, which is an s-polarized component on the first substrate 5 side, changes to a p-polarized component as distance from the second substrate 6 decreases. This rotation of the polarized component may be referred to as optical rotation.

FIG. 8A illustrates a state in which no potential is generated between adjacent electrodes in each liquid crystal cell 2. In this case, only optical rotation occurs in each liquid crystal cell 2 and no polarized component is diffused.

As illustrated in FIG. 8B, for example, when potential difference is generated between the drive electrodes 10a and 10b on the first substrate 5 in the first liquid crystal cell 2_1, the liquid crystal molecules between the electrodes are aligned in a circular arc shape, and thus, refractive index distribution is formed in the Dx direction in the liquid crystal layer 8. As light from the light source 4 is transmitted in this state, the above-described refractive index distribution acts on the polarized component (in FIG. 8B, p-polarized component) parallel to the Dx direction, and therefore, the p-polarized component diffuses in the Dx direction.

In addition, when potential difference is generated between the drive electrodes 13a and 13b on the second substrate 6 side in the first liquid crystal cell 2_1, refractive index distribution is formed in the Dy direction on the second substrate 6 side, and accordingly, the s-polarized component diffuses in the Dy direction on the second substrate 6 side. Specifically, the polarized component having changed from a p-polarized component to an s-polarized component during passing through the liquid crystal layer 8 in the first liquid crystal cell 2_1 diffuses in the Dy direction as well. However, the s-polarized component at incidence on the first liquid crystal cell 2_1 optically rotates during passing through the liquid crystal layer 8 but intersects each refractive index distribution, and accordingly, only optically rotates without diffusing and passes through the first liquid crystal cell 2_1.

The s-polarized component at incidence on the first liquid crystal cell 2_1 changes to a p-polarized component after passing through the first liquid crystal cell 2_1, and the second liquid crystal cell 2_2 acts on this p-polarized component. Specifically, as illustrated in FIGS. 8A and 8B, the first liquid crystal cell 2_1 acts on the p-polarized component of light incident on the optical element 100, and the second liquid crystal cell 2_2 acts on the s-polarized component thereof. Since the third liquid crystal cell 2_3 and the fourth liquid crystal cell 2_4 are provided with rotation by 90° relative to the first liquid crystal cell 2_1 and the second liquid crystal cell 2_2, polarized components on which they act are switched by 90°. Specifically, the third liquid crystal cell 2_3 acts on the s-polarized component at incidence on the optical element 100, and the fourth liquid crystal cell 2_4 acts on the p-polarized component at incidence on the optical element 100.

As illustrated in FIG. 8C, in the optical element, it is possible to act on the p-polarized component by providing potential difference between drive electrodes extending in the Dy direction in each liquid crystal cell 2 (between the drive electrodes 10a and 10b of the first substrate 5 in the first liquid crystal cell 2_1 and the second liquid crystal cell 2_2 and between the drive electrodes 13a and 13b of the second substrate 6 in the third liquid crystal cell 2_3 and the fourth liquid crystal cell 2_4), thereby increasing the shape of light mainly in the Dx direction. This effect may be referred to as horizontal diffusion.

As illustrated in FIG. 8D, it is possible to act on the s-polarized component by providing potential difference between drive electrodes extending in the Dx direction in each liquid crystal cell 2 (between the drive electrodes 13a and 13b of the second substrate 6 in the first liquid crystal cell 2_1 and the second liquid crystal cell 2_2 and between the drive electrodes 10a and 10b of the first substrate 5 in the third liquid crystal cell 2_3 and the fourth liquid crystal cell 2_4), thereby increasing the shape of light mainly in the Dy direction. This effect may be referred to as vertical diffusion.

The diffusion degree of light in each direction depends on the potential difference between the drive electrodes 10a and 10b (or between the drive electrodes 13a and 13b) adjacent to each other. The spread of light in the direction is maximum (100%) in a case where the potential difference between the drive electrodes 10a and 10b (or between the drive electrodes 13a and 13b) is maximum potential difference (for example, 30 V) defined in advance, and no spread of light (0%) occurs in the direction in a case where no potential difference is generated. Alternatively, the spread of light in the direction is 50% in a case where the potential difference between the drive electrodes 10a and 10b (or between the drive electrodes 13a and 13b) is 50% (for example, 15 V) of the above-described maximum potential difference. In a case where the relation between voltage difference and light spread is not linear, it is possible to set another potential difference instead of 15 V.

In each liquid crystal cell 2, the interval (also referred to as a cell gap) between its substrates (between the first substrate 5 and the second substrate 6) is large and is 30 μm to 50 μm approximately, and thus, influence of an electric field formed in one of the substrates on the other substrate side is reduced as much as possible. Drive voltage that generates potential difference between the drive electrodes 10a and 10b (or between the drive electrodes 13a and 13b) adjacent to each other is what is called an alternating-current square wave, thereby preventing burn-in of the liquid crystal molecules.

The alignment directions of the alignment films, the extending directions of the drive electrodes on the substrates, and the angle between them may be modified as appropriate for the entire optical element 100 or each liquid crystal cell 2 in accordance with the characteristics of liquid crystals to be employed and optical characteristics to be intentionally obtained.

In the present embodiment, description is made on the configuration of the optical element 100 in which the four liquid crystal cells of the first liquid crystal cell 2_1, the second liquid crystal cell 2_2, the third liquid crystal cell 2_3, and the fourth liquid crystal cell 2_4 are stacked, but the optical element 100 is not limited to this configuration and may employ, for example, a configuration in which two or three liquid crystal cells 2 are stacked or a configuration in which a plurality of liquid crystal cells 2, five or more liquid crystal cells 2, are stacked.

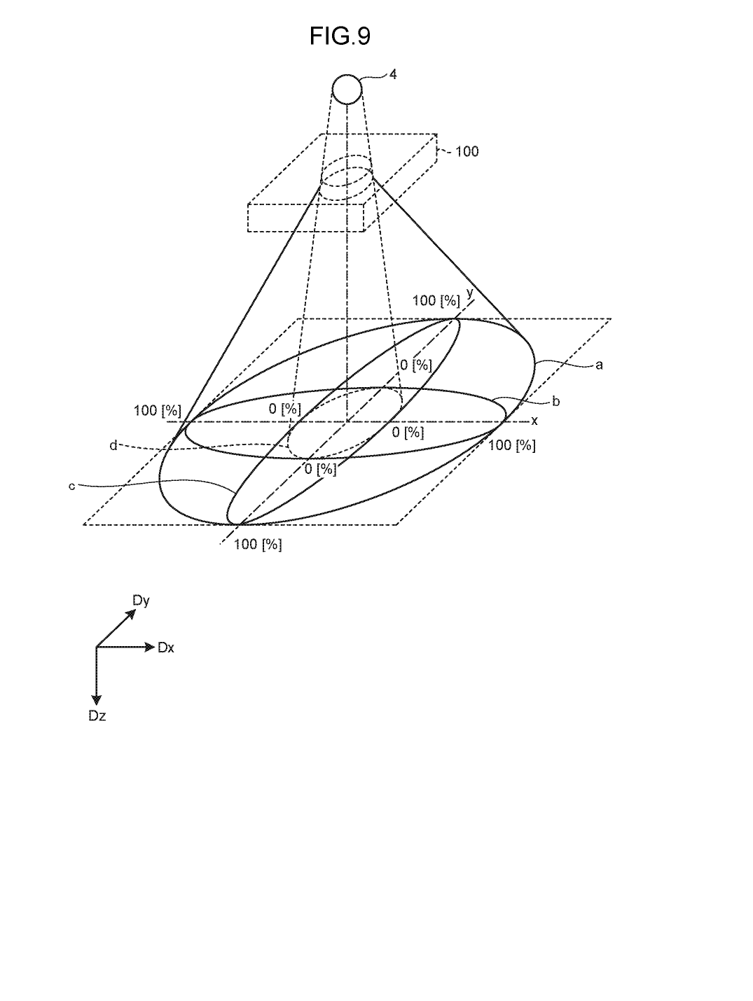

In the present disclosure, in the optical communication device 1 with the above-described configuration, light incident on the optical element from the light source 4 is controlled in the two directions of the Dx direction (direction of horizontal diffusion) and the Dy direction (direction of vertical diffusion) by controlling drive voltage of each liquid crystal cell 2. The above-described vertical diffusion and horizontal diffusion may be collectively referred to as light diffusion. Accordingly, the shape of light emitted from the optical element is changed. The shape of light is a light shape that appears on a plane parallel to an emission surface of the optical element, and this may be referred to as a light distribution shape. Hereinafter, control of the light diffusion degree in the present disclosure will be described below with reference to FIG. 9.

FIG. 9 is a conceptual diagram for conceptually describing control of the light diffusion degree of the optical communication device according to the embodiment. FIG. 9 illustrates an irradiation area of light on a virtual plane xy orthogonal to the Dz direction. The outline of the actual irradiation area is slightly unclear depending on the distance from the light source 4, a light diffraction phenomenon, and the like.

As described above, drive voltage is supplied to the drive electrodes 10 and 13 of each liquid crystal cell 2 of the optical element 100 provided on the optical axis of the light source 4, whereby the alignment direction of the liquid crystal molecules 17 in the liquid crystal layer 8 is controlled. With this control, the light distribution shape of light emitted from the optical element 100 is controlled.

Specifically, for example, the light distribution shape in the Dx direction changes depending on the drive voltage applied to the drive electrodes 10 or drive electrodes 13 extending in the Dy direction in each liquid crystal cell 2 as described above. Such light diffusion in the Dx direction may be referred to as horizontal diffusion. The light distribution shape in the Dy direction changes depending on the drive voltage applied to the drive electrodes 10 or drive electrodes 13 extending in the Dx direction in the first to fourth liquid crystal cells. Such light diffusion in the Dy direction may be referred to as vertical diffusion.

In the present disclosure, the minimum diffusion degrees of the horizontal diffusion and the vertical diffusion are 0% and the maximum diffusion degrees thereof are 100%. More specifically, in a case where the horizontal diffusion degree is 0%, drive electrodes (for example, the drive electrodes 10 extending in the Dy direction on the first substrate 5 in the first liquid crystal cell 2_1) functioning to expand the light distribution state in the Dx direction do not act on the refractive index distribution of the liquid crystal layer 8. In this case, no potential difference is present between the adjacent drive electrodes 10a and 10b or no potential is supplied to the electrodes. On the other hand, in a case where the horizontal diffusion degree is 100%, drive electrodes (for example, the drive electrodes 10 extending in the Dy direction on the first substrate 5 in the first liquid crystal cell 2_1) functioning to expand the light distribution state in the Dx direction maximally act on the refractive index distribution of the liquid crystal layer 8. In this case, the potential difference between the adjacent drive electrodes 10a and 10b is set to the maximum potential difference (for example, 30 V) in the optical element 100. In a case where the horizontal diffusion degree is larger than 0% and smaller than 100%, potential adjusted such that the potential difference between the adjacent drive electrodes 10a and 10b is larger than 0 V and smaller than the maximum potential difference (for example, 30 V) is applied to the electrodes. The same applies to the vertical diffusion.

Outline "a" illustrated in FIG. 9 exemplarily indicates the irradiation area in a case where the horizontal diffusion degree and the vertical diffusion degree are both 100%. Outline "b" illustrated in FIG. 9 exemplarily indicates the irradiation area in a case where the horizontal diffusion degree is 100% and the vertical diffusion degree is 0%. Outline "c" illustrated in FIG. 9 exemplarily indicates the irradiation area in a case where the horizontal diffusion degree is 0% and the vertical diffusion degree is 100%. Outline "d" illustrated in FIG. 9 exemplarily indicates the irradiation area in a case where the horizontal diffusion degree and the vertical diffusion degree are both 0%. In other words, outline "d" indicates the light distribution state when light from the light source 4 is emitted without being controlled by the optical element 100 (or simply transmitted through the optical element 100).

In the optical communication device 1 with the above-described configuration, it is possible to control the horizontal and vertical diffusion degrees of emission light from the optical element 100 by performing drive voltage control of each liquid crystal cell 2. Accordingly, it is possible to change the light distribution shape of emission light from the optical communication device 1. Hereinafter, control that changes the light distribution shape of emission light from the optical communication device 1 is also referred to as "light distribution control".

The following describes a method of transmitting Morse-encoded information by using the optical communication device 1 in which the light distribution shape of light can be controlled as described above.

### First embodiment

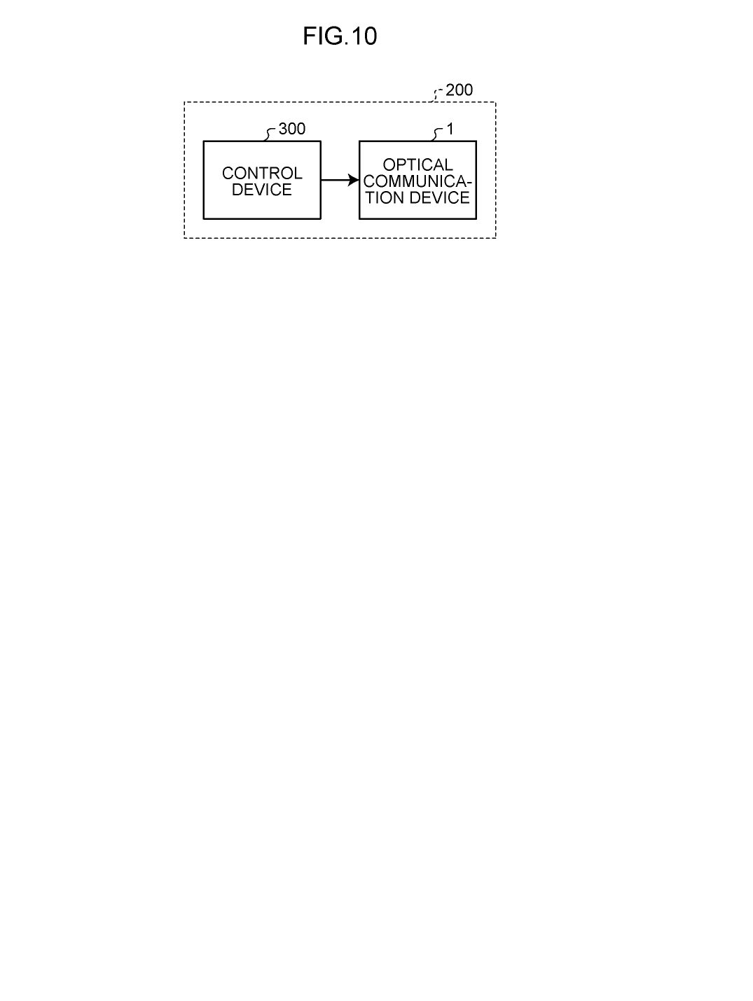

FIG. 10 is a diagram illustrating a schematic configuration of an optical communication system 200 according to a first embodiment. As illustrated in FIG. 10, the optical communication system 200 according to the first embodiment includes the optical communication device 1 and a control device 300. The control device 300 is, for example, a portable communication terminal device such as a smartphone or a tablet. In the present disclosure, the optical communication device 1 includes the optical element 100 described above and is configured such that light distribution can be controlled in the two directions of the Dx and Dy directions.

Data and various command signals are transmitted bidirectionally between the control device 300 and the optical communication device 1 through a communication means. In the present disclosure, the communication means is a wireless communication means of, for example, Bluetooth (registered trademark) or WiFi (registered trademark). Wireless communication may be performed between the control device 300 and the optical communication device 1 through, for example, a predetermined network such as a mobile communication network. Alternatively, the control device 300 and the optical communication device 1 may be coupled in a wired manner to perform wired communication therebetween.

In the present disclosure, the control device 300 has a function of transmitting, to the optical communication device 1, character information to be converted into Morse code and various pieces of setting information necessary for Morse code encoding and transmission. The optical communication device 1 Morse-code-encodes the character information transmitted from the control device 300 based on the various pieces of setting information and transmits the Morse-encoded character information.

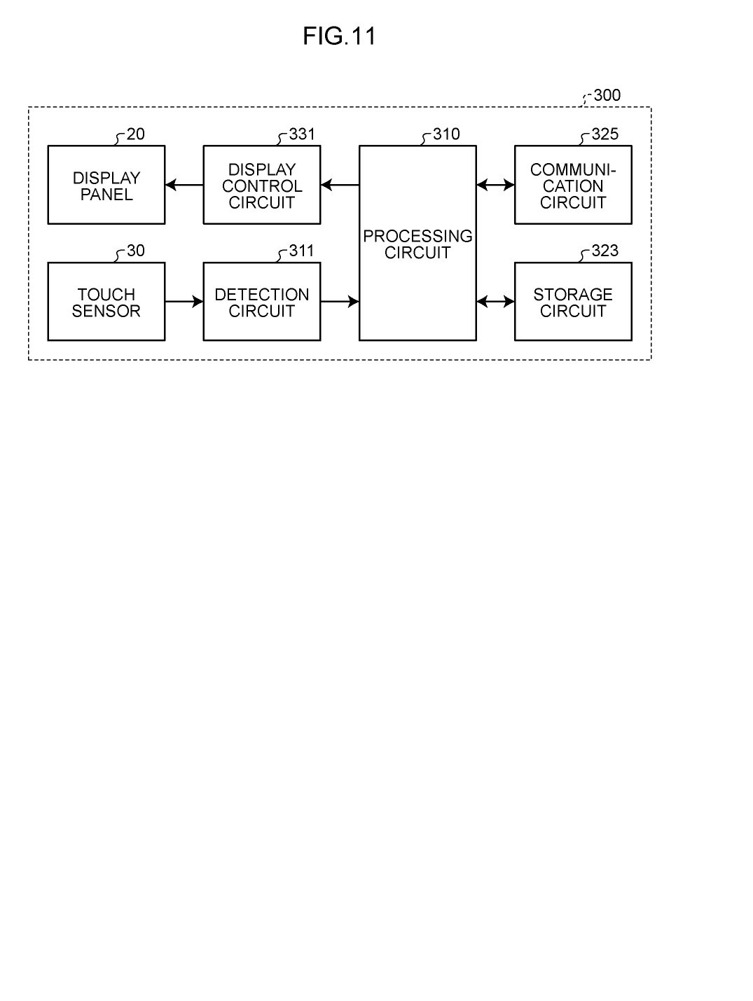

FIG. 11 is a block diagram illustrating an example of the control device 300 according to the first embodiment. As illustrated in FIG. 11, the control device 300 according to the first embodiment includes a display panel 20, a touch sensor 30, a processing circuit 310, a detection circuit 311, a storage circuit 323, a communication circuit 325, and a display control circuit 331.

The display control circuit 331 is a circuit that executes display control processing of the display panel 20. The detection circuit 311 is a circuit that detects the presence or absence of a touch on the touch sensor 30 based on a detection signal output from each detection element 31 of the touch sensor 30. The detection circuit 311 is configured with, for example, a detection IC. Alternatively, the detection circuit 311 and the display control circuit 331 may be mounted on the display panel 20 as one display IC. The display panel 20, the touch sensor 30, the detection circuit 311, and the display control circuit 331 function as a human machine interface (HMI) in the control device 300.

The processing circuit 310 is, for example, a component achieved by the CPU of the smartphone or tablet constituting the control device 300.

The storage circuit 323 is, for example, a component achieved by the RAM, EEPROM, and ROM of the smartphone or tablet constituting the control device 300.

The communication circuit 325 is configured with, for example, a wireless communication module of the smartphone or tablet constituting the control device 300. The communication circuit 325 is a circuit that communicates with the optical communication device 1.

In the present disclosure, the character information (hereinafter also referred to as a "message") and the various pieces of setting information to be transmitted to the optical communication device 1 are stored in the storage circuit 323.

The various pieces of setting information in the first embodiment include information on the language (Western language or Japanese language) of the message, a repetition count R, a code length s, a code interval i, and a message interval e. The content of the body of the message and setting values of the various pieces of setting information may be input in a manner in which a user operates the control device 300, or may be transmitted from a non-illustrated external device to the control device 300 and stored in the storage circuit 323.

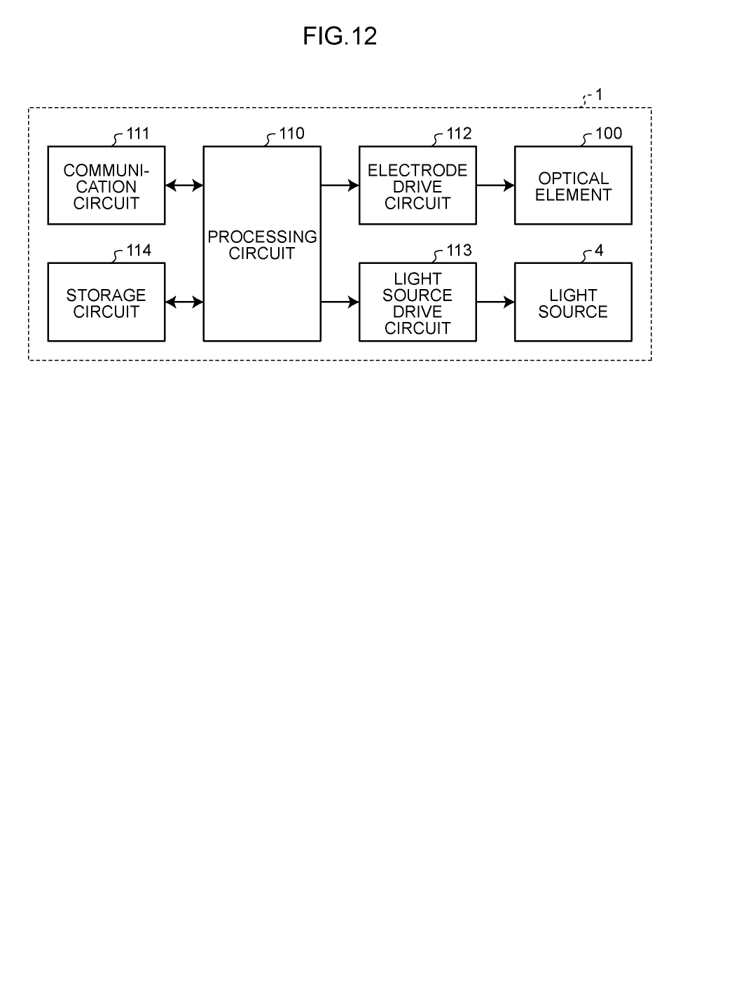

FIG. 12 is a block diagram illustrating an example of the optical communication device 1 according to the first embodiment. As illustrated in FIG. 12, the optical communication device 1 according to the first embodiment includes a processing circuit 110, a communication circuit 111, an electrode drive circuit 112, a light source drive circuit 113, and a storage circuit 114 as control blocks for controlling the light source 4 and the optical element 100 described above.

The electrode drive circuit 112 is a circuit that supplies a drive voltage corresponding to a light distribution shape to the drive electrodes 10 and 13 of each liquid crystal cell 2 of the optical element 100. In the optical communication device 1, a light distribution control rate is defined by the sampling rate (samples per second (sps)) of a DA converter for electrode driving. The light source drive circuit 113 is a circuit that supplies, to the light source 4, a driving current based on control parameters such as light emission intensity and light emission color. The processing circuit 110 is configured with, for example, a microcomputer. The storage circuit 114 is configured with, for example, a RAM, an EEPROM, or a ROM. The communication circuit 111 is a circuit that communicates with the control device 300.

In the present disclosure, the message and the various pieces of setting information transmitted from the control device 300 are stored in the storage circuit 114. The processing circuit 110 converts the message transmitted from the control device 300 into Morse code.

Morse code is a character code that is variable-length encoded by combining a short dot code "·" and a long dot code "-", and is typically transmitted as a Morse signal subjected to pulse width modulation (PWM). In this case, the short dot code "·" and the long dot code "-" are defined by a code length. Thus, a transmission time may become long depending on the content or the amount of information of the message.

In the present disclosure, the optical communication device 1 performs information transmission by combining a first light distribution shape corresponding to a short dot code "·" and a second light distribution shape corresponding to a long dot code "-". In other words, in the present disclosure, a short dot code "·" and a long dot code "-" are defined by the light distribution shape of the optical communication device 1. Thus, the transmission time of Morse-encoded information can be shortened.

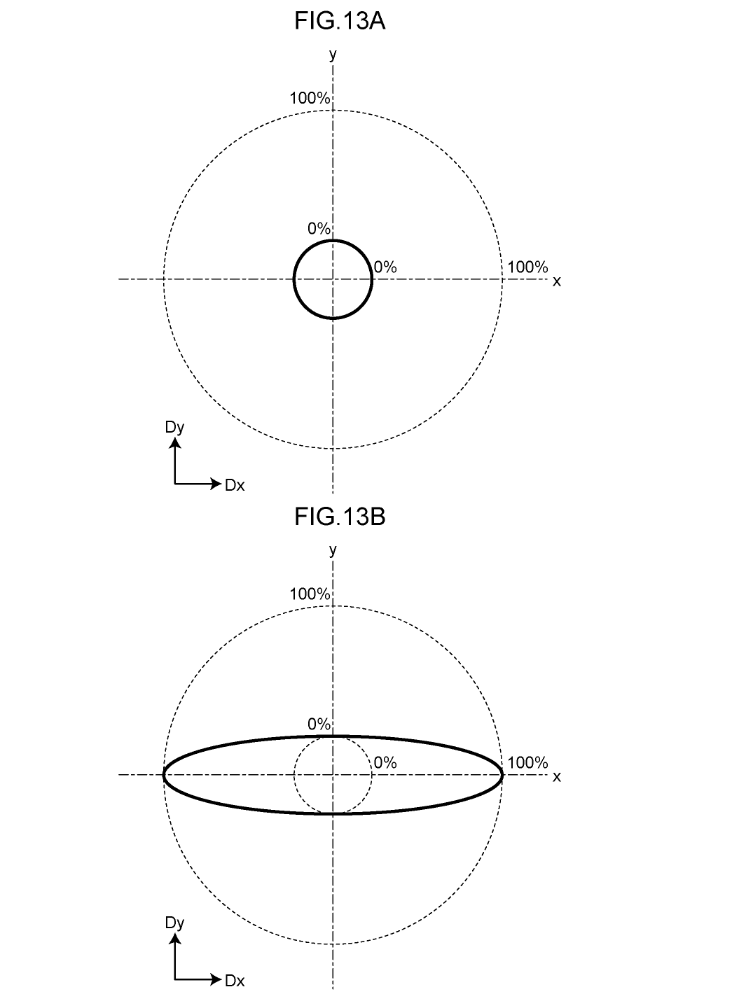

FIG. 13A is a diagram illustrating a specific example of the first light distribution shape. FIG. 13B is a diagram illustrating a specific example of the second light distribution shape. An example of the first light distribution shape is, for example, a light distribution state in which both the horizontal diffusion degree and the vertical diffusion degree are 0% as illustrated in FIG. 13A. An example of the second light distribution shape is, for example, a light distribution state in which the horizontal diffusion degree is 100% and the vertical diffusion degree is 0% as illustrated in FIG. 13B.

In the present embodiment, the length of a period during which the first light distribution shape or the second light distribution shape is maintained in information transmission processing to be described later is defined as the a "code length s". The interval between consecutive codes is defined as the a "code interval i". A repetition interval at which a series of messages is repeatedly transmitted is defined as the "message interval e".

The first light distribution shape and the second light distribution shape are not limited to the examples illustrated in FIGS. 13A and 13B. The first light distribution shape and the second light distribution shape only need to be different shapes. Specifically, for example, the second light distribution shape may be a light distribution state in which the horizontal diffusion degree is 0% and the vertical diffusion degree is 100%, or may be a light distribution state in which both the horizontal diffusion degree and the vertical diffusion degree are 100%.

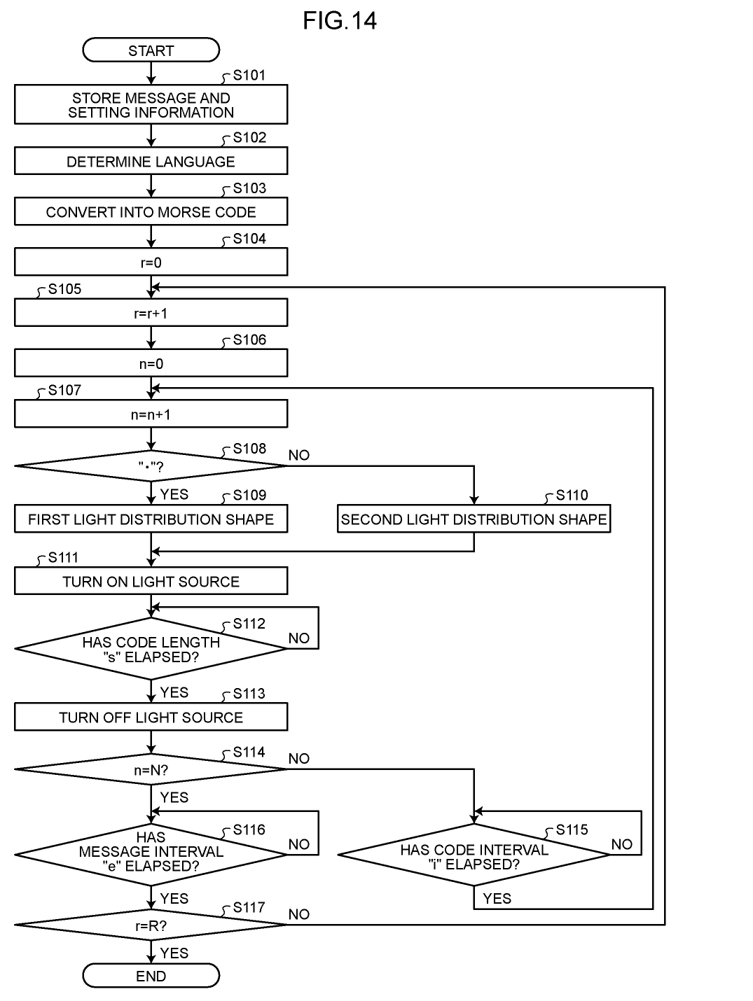

FIG. 14 is a flowchart illustrating an example of the information transmission processing in the optical communication system 200 according to the first embodiment. The following description will be made on an example in which the information transmission processing illustrated in FIG. 14 is started when the optical communication device 1 receives the message transmitted from the control device 300.

The message (character information) transmitted from the control device 300, and the various pieces of setting information such as information on the language (Western language or Japanese language) of the message, the repetition count R, the code length s, the code interval i, the message interval e are stored in the storage circuit 114 of the optical communication device 1 (step S101).

The processing circuit 110 of the optical communication device 1 determines whether the message (character information) is in a Western language or a Japanese language (step S102), converts the message into Morse code (step S103), and stores the Morse-encoded message in the storage circuit 114.

In the present disclosure, a conversion table used when the message (character information) is converted into Morse code is stored in the storage circuit 114 in advance. A known Morse code table may be used as the conversion table. Hereinafter, the Morse-encoded message is also referred to as a "character information code".

The number of codes (total number of short dot codes "·" and long dot codes "-") of the character information code is defined as N. The processing circuit 110 resets a repetition number r (r = 0; step S104), and increments the repetition number r (r = r + 1; step S105), wherein r is an integer equal to or smaller than R. Subsequently, the processing circuit 110 resets a code number n (n = 0; step S106), and increments the code number n (n = n + 1; step S107), wherein n is an integer equal to or smaller than N.

The processing circuit 110 reads the n-th code of the character information code, and determines whether the code is a short dot code "·" or a long dot code "-". Specifically, the processing circuit 110 determines whether the n-th code of the character information code is a short dot code "·" (step S108).

When the n-th code of the character information code is a short dot code "·" (Yes at step S108), the processing circuit 110 controls the electrode drive circuit 112 to supply, to each of the drive electrodes 10 and 13 of each liquid crystal cell 2 of the optical element 100, a drive voltage with which the light distribution state of the optical element 100 becomes the first light distribution shape (step S109).

When the n-th code of the character information code is a long dot code "-" (No at step S108), the processing circuit 110 controls the electrode drive circuit 112 to supply, to each of the drive electrodes 10 and 13 of each liquid crystal cell 2 of the optical element 100, a drive voltage with which the light distribution state of the optical element 100 becomes the second light distribution shape (step S110).

Then, the processing circuit 110 controls the light source drive circuit 113 to turn on the light source 4 (step S111). Accordingly, the n-th code is transmitted.

The processing circuit 110 determines whether the code length s has elapsed (step S112). When the code length s has not elapsed (No at step S112), the processing of step S112 is repeatedly executed until the code length s elapses. When the code length s has elapsed (Yes at step S112), the processing circuit 110 controls the light source drive circuit 113 to turn off the light source 4 (step S113). The code length s is set to, for example, 500 ms.

Subsequently, the processing circuit 110 determines whether the code number n has reached the number of codes N of the character information code (step S114).

When the code number n is less than the number of codes N of the character information code (No at step S114), the processing circuit 110 determines whether the code interval i has elapsed (step S115). When the code interval i has not elapsed (No at step S115), the processing of step S115 is repeatedly executed until the code interval i elapses. When the code interval i has elapsed (Yes at step S115), the processing circuit 110 returns to the processing of step S107 and repeatedly executes the processing up to step S114. The code interval i is set to, for example, 100 ms.

When the code number n has reached the number of codes N of the character information code (Yes at step S114), the processing circuit 110 determines whether the message interval e has elapsed (step S116). When the message interval e has not elapsed (No at step S116), the processing of step S116 is repeatedly executed until the message interval e elapses. The message interval e is set to, for example, 1000 ms.

When the message interval e has elapsed (Yes at step S116), the processing circuit 110 determines whether the repetition number r has reached the repetition count R (step S117). When the repetition number r is less than the repetition count R (No at step S117), the processing circuit 110 returns to the processing of step S105 and repeatedly executes the processing up to step S117.

When the repetition number r has reached the repetition count R (Yes at step S117), the information transmission processing illustrated in FIG. 14 ends.

In the optical communication device 1 and the optical communication system 200 according to the first embodiment described above, the processing circuit 110 of the optical communication device 1 generates the character information code obtained by converting the message (character information) into Morse code, controls the light distribution state of the optical element 100 to the first light distribution shape when transmitting a short dot code "·" of the generated character information code, and controls the light distribution state of the optical element 100 to the second light distribution shape different from the first light distribution shape when transmitting a long dot code "-" of the character information code. Accordingly, the Morse-encoded message (character information) can be interpreted by visually recognizing the light distribution state of the optical element 100 in the optical communication device 1.

### Second embodiment

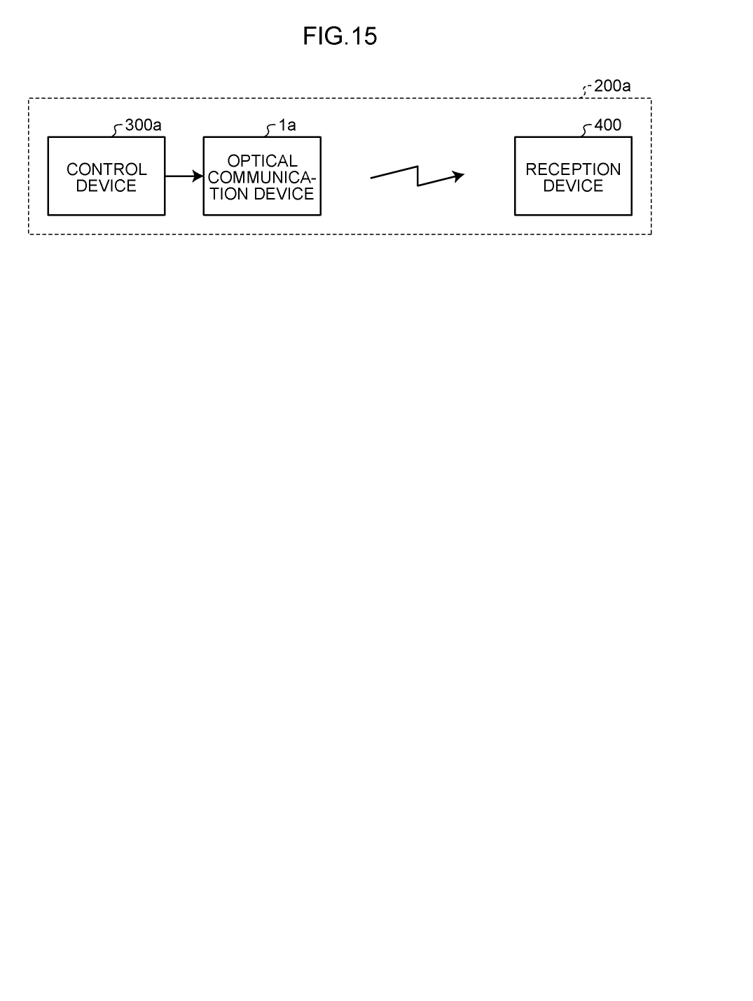

FIG. 15 is a diagram illustrating a schematic configuration of an optical communication system according to a second embodiment. As illustrated in FIG. 15, an optical communication system 200a according to the second embodiment includes an optical communication device 1a, the control device 300, and a reception device 400. The reception device 400 is, for example, a portable communication terminal device such as a smartphone or a tablet.

In the present disclosure, the reception device 400 has a function of decoding Morse code transmitted from the optical communication device 1a. In the optical communication system 200a according to the second embodiment, a protocol (hereinafter also referred to as a "transmission protocol") related to transmission of Morse code is shared in advance between the optical communication device 1a and the reception device 400. In the transmission protocol, a format of header information including the various pieces of setting information for transmitting the character information code, a data transmission rate b (second data transmission rate) for transmitting the header information, and the like are defined.

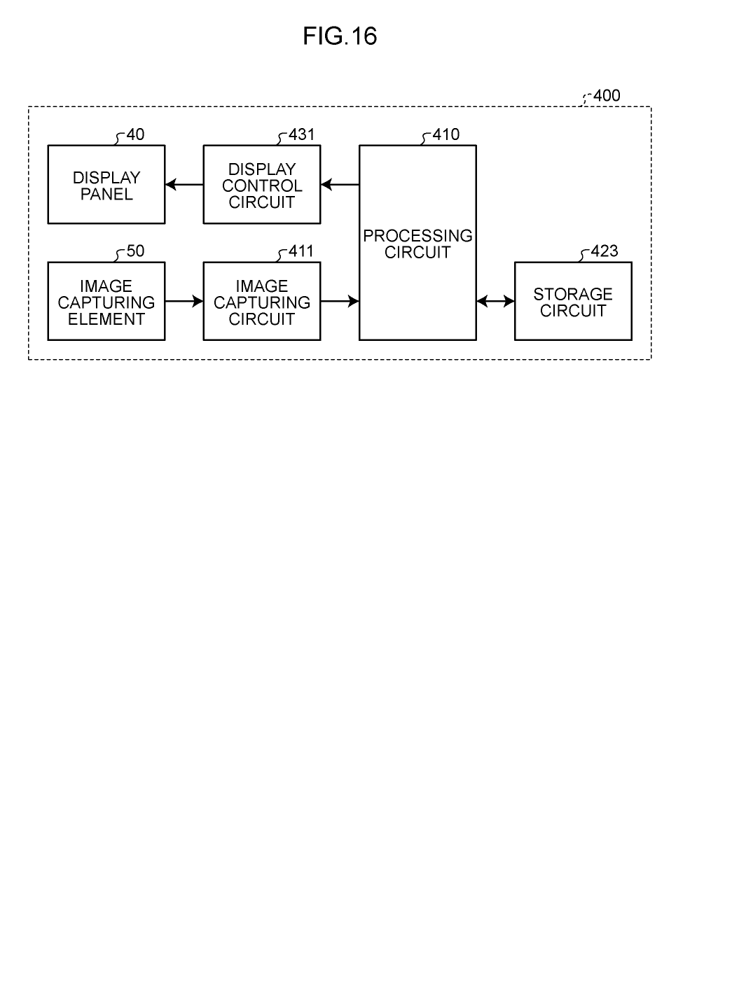

FIG. 16 is a block diagram illustrating an example of the reception device 400 according to the second embodiment. As illustrated in FIG. 16, the reception device 400 according to the second embodiment includes a display panel 40, an image capturing element 50, a processing circuit 410, an image capturing circuit 411, a storage circuit 423, and a display control circuit 431.

In the present disclosure, the image capturing element 50 is an image sensor that acquires a change in the light distribution state of the optical communication device 1a. The image sensor is, for example, a solid-state image capturing element such as a complementary metal oxide semiconductor (CMOS) image sensor, but is not limited thereto, and may be, for example, a charge coupled device (CCD) image sensor.

The display control circuit 431 is a circuit that executes display control processing of the display panel 40. The image capturing circuit 411 is a circuit that acquires the light distribution state of the optical communication device 1a based on a pixel signal output from each pixel of the image capturing element 50. The image capturing circuit 411 is configured with, for example, an image processing integrated circuit (IC). The display panel 40 and the display control circuit 431 function as a human machine interface (HMI) in the reception device 400. The image capturing element 50 and the image capturing circuit 411 function as a camera for acquiring the light distribution state of the optical communication device 1a as image data.

The processing circuit 410 is, for example, a component achieved by the CPU of the smartphone or tablet constituting the reception device 400.

The storage circuit 423 is, for example, a component achieved by the RAM, EEPROM, and ROM of the smartphone or tablet constituting the reception device 400.

In the present disclosure, the image data acquired by the camera (the image capturing element 50 and the image capturing circuit 411) is stored in the storage circuit 423. The processing circuit 410 analyzes the acquired image data and decodes Morse code transmitted from the optical communication device 1a.

The various pieces of setting information in the second embodiment include information on the language (Western language or Japanese language) of the message, a data transmission rate B (first data transmission rate) for transmitting the character information code, and the repetition count R. The content of the message and setting values of the various pieces of setting information may be input in a manner in which a user operates a control device 300a, or may be transmitted from a non-illustrated external device to the control device 300a and stored in the storage circuit 323.

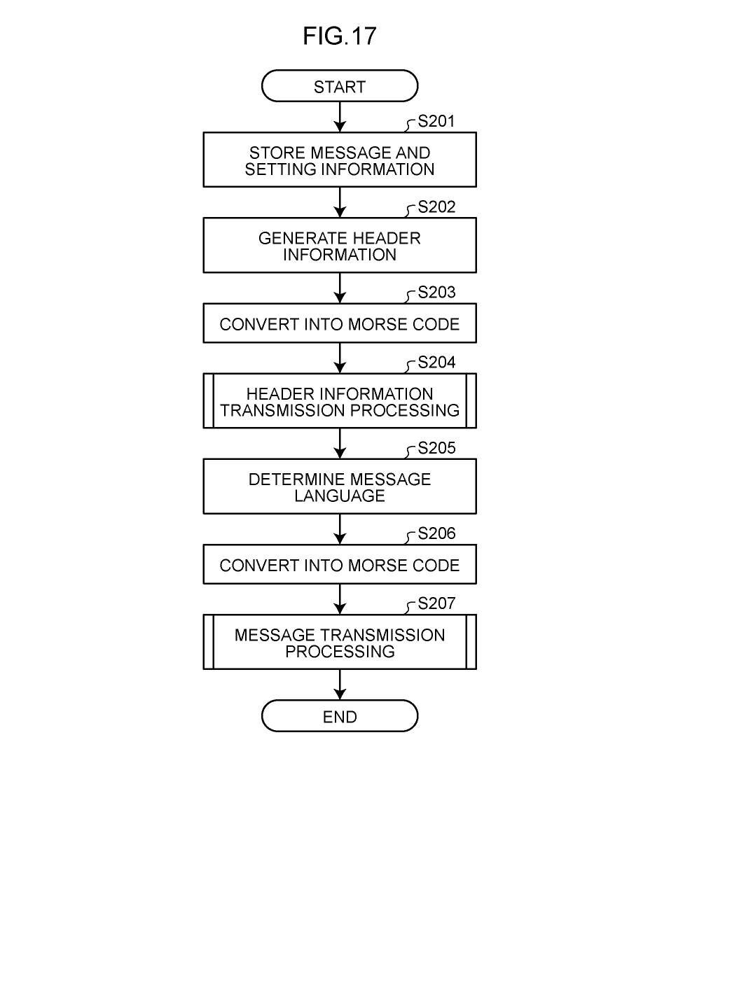

FIG. 17 is a flowchart illustrating an example of information transmission processing in the optical communication system 200a according to the second embodiment. The following description will be made on an example in which the information transmission processing illustrated in FIG. 17 is started when the optical communication device 1a receives the message transmitted from the control device 300a.

The message (character information) and the various pieces of setting information such as the language (Western language or Japanese language) of the message, the data transmission rate B, and the repetition count R, transmitted from the control device 300a, are stored in the storage circuit 114 of the optical communication device 1a (step S201).

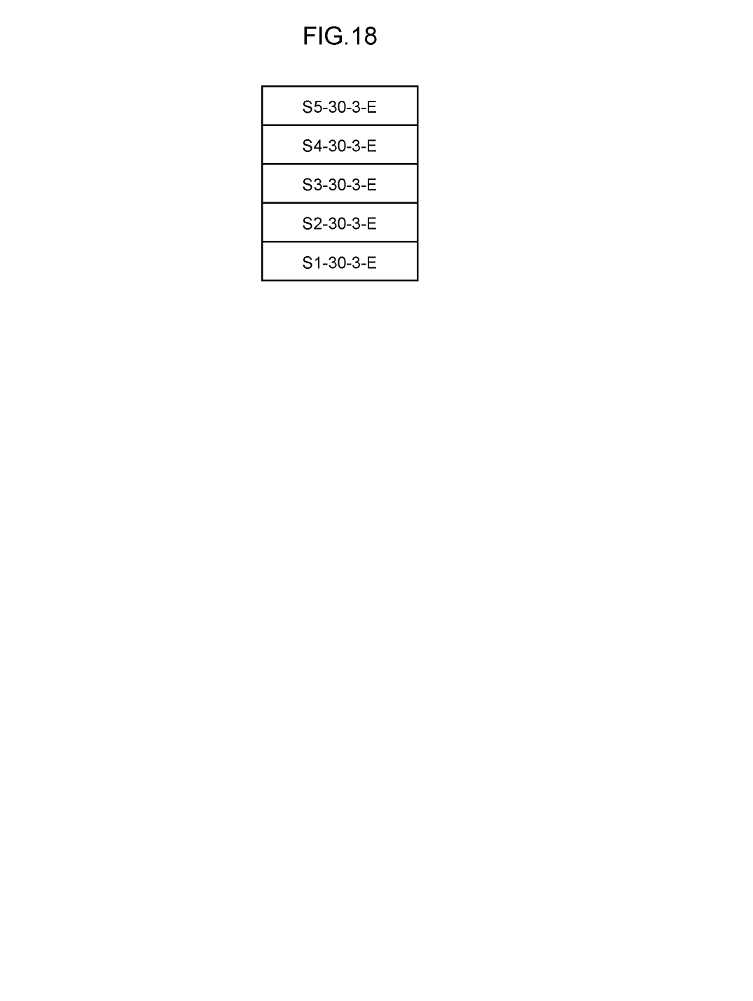

The processing circuit 110 of the optical communication device 1a generates header information (step S202), converts the header information into Morse code (step S203), and stores the Morse-encoded header information in the storage circuit 114. FIG. 18 is a diagram illustrating an example of the header information.

FIG. 18 illustrates an example of a plurality of pieces of header information defined by a header information number P (in FIG. 18, "5", "4", ..., "1"). Each piece of header information includes a start code "S" indicating a start position, the header information number P (in FIG. 18, "5", "4", ..., "1"), the data transmission rate B (in FIG. 18, "30" (bits per second (bps))), the repetition count R (in FIG. 18, "3" (times)), and an end code "E" indicating an end position.

A conversion table used when the header information is converted into Morse code may be the same conversion table as when the message (character information) is converted into Morse code. Hereinafter, the header information corresponding to the Morse-encoded header information number P (in FIG. 18, "5", "4", ..., "1") is also referred to as a "header code".

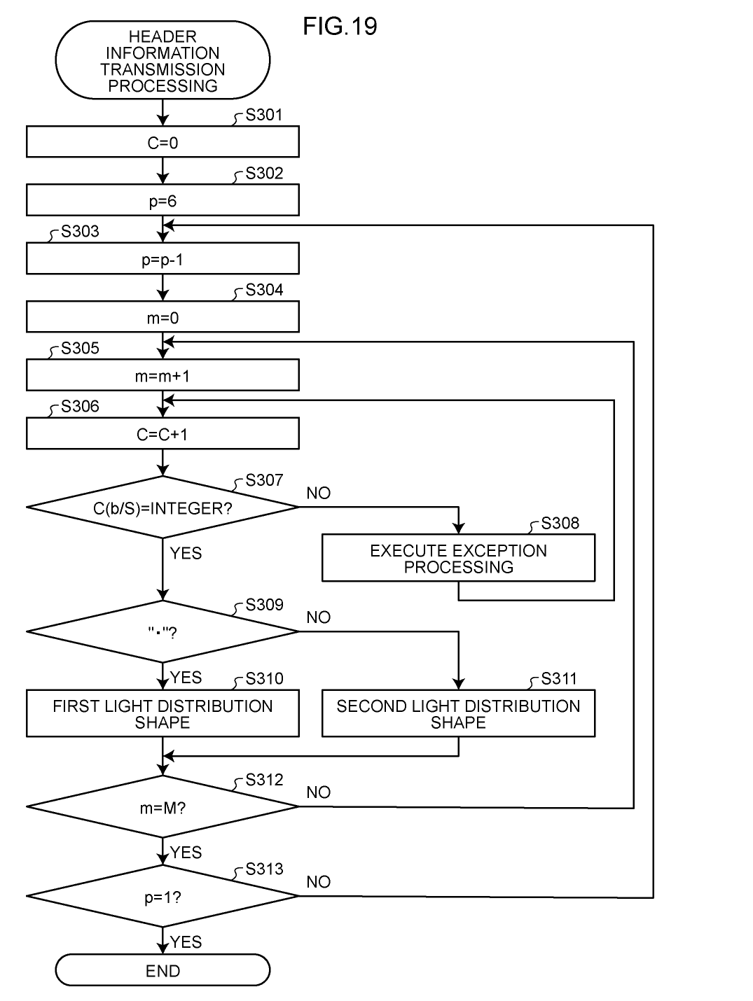

The processing circuit 110 executes header information transmission processing (step S204). FIG. 19 is a sub flowchart illustrating an example of the header information transmission processing.

In the header information transmission processing illustrated in FIG. 19, the processing circuit 110 first resets a light distribution control counter value C of the optical communication device 1a at a light distribution control rate S (C = 0; step S301). Then, the processing circuit 110 resets a countdown number p (p = 6; step S302), and decrements the countdown number p (p = p - 1; step S303), wherein p is an integer equal to or smaller than P + 1. Subsequently, the processing circuit 110 sets the number of codes (total number of short dot codes "·" and long dot codes "-") of the header code to M, resets a code number m (m = 0; step S304), and increments the code number m (m = m + 1; step S305), wherein m is an integer equal to or smaller than M.

Subsequently, the processing circuit 110 increments the light distribution control counter value C (C = C + 1; step S306), and determines whether the value of C(b/S) is an integer (step S307).

When the value of C(b/S) is not an integer value (No at step S307), the processing circuit 110 executes exception processing that is different from light distribution control in the header information transmission processing (step S308). Specifically, in the exception processing, the processing circuit 110 controls the electrode drive circuit 112 to supply, to each of the drive electrodes 10 and 13 of each liquid crystal cell 2 of the optical element 100, a drive voltage with which the light distribution state of the optical element 100 becomes substantially different from the first light distribution shape and the second light distribution shape.

After executing the exception processing at step S308, the processing circuit 110 returns to the processing of step S306 and repeatedly executes the processing of step S306 to step S308.

When the value of C(b/S) is an integer value (Yes at step S307), the processing circuit 110 reads the m-th code of the header code, and determines whether the m-th code is a short dot code "·" or a long dot code "-". Specifically, the processing circuit 110 determines whether the m-th code is a short dot code "·" (step S309).

When the m-th code of the header code is a short dot code "·" (Yes at step S309), the processing circuit 110 controls the electrode drive circuit 112 to supply, to each of the drive electrodes 10 and 13 of each liquid crystal cell 2 of the optical element 100, a drive voltage with which the light distribution state of the optical element 100 becomes the first light distribution shape (step S310).

When the m-th code of the header code is a long dot code "-" (No at step S309), the processing circuit 110 controls the electrode drive circuit 112 to supply, to each of the drive electrodes 10 and 13 of each liquid crystal cell 2 of the optical element 100, a drive voltage with which the light distribution state of the optical element 100 becomes the second light distribution shape (step S311). Accordingly, the m-th code of the header code is transmitted.

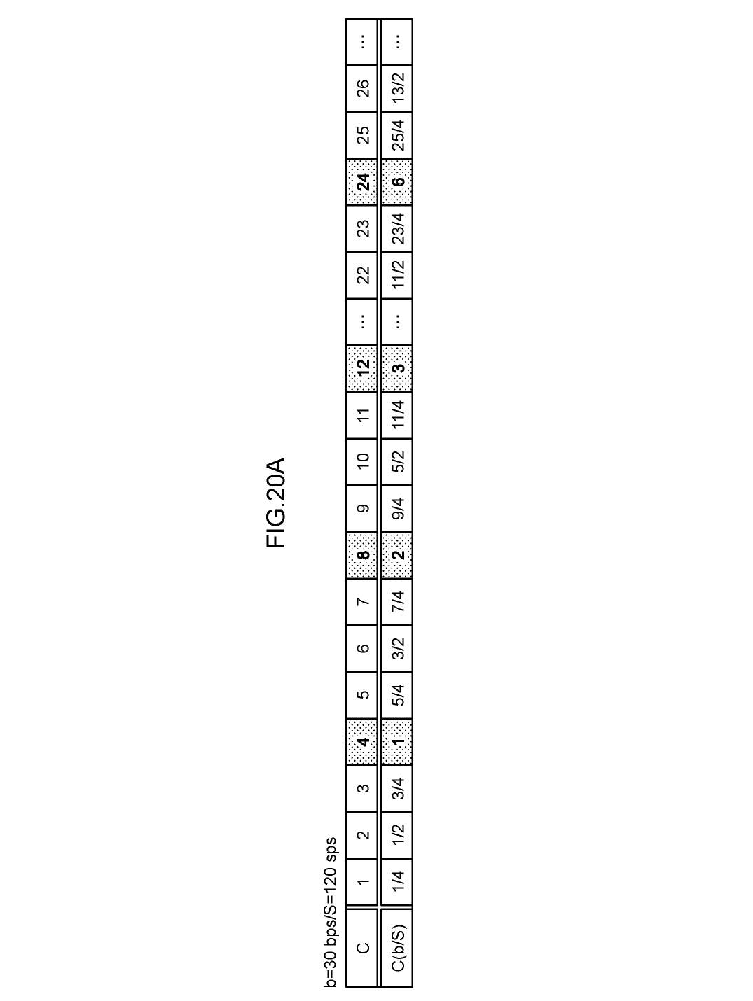

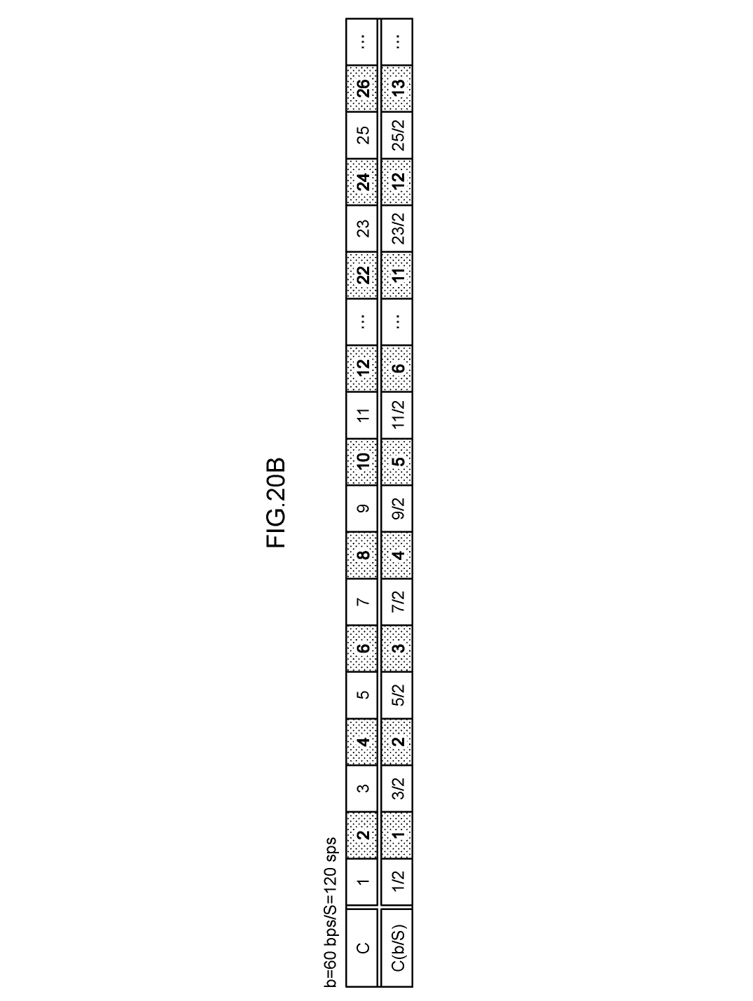

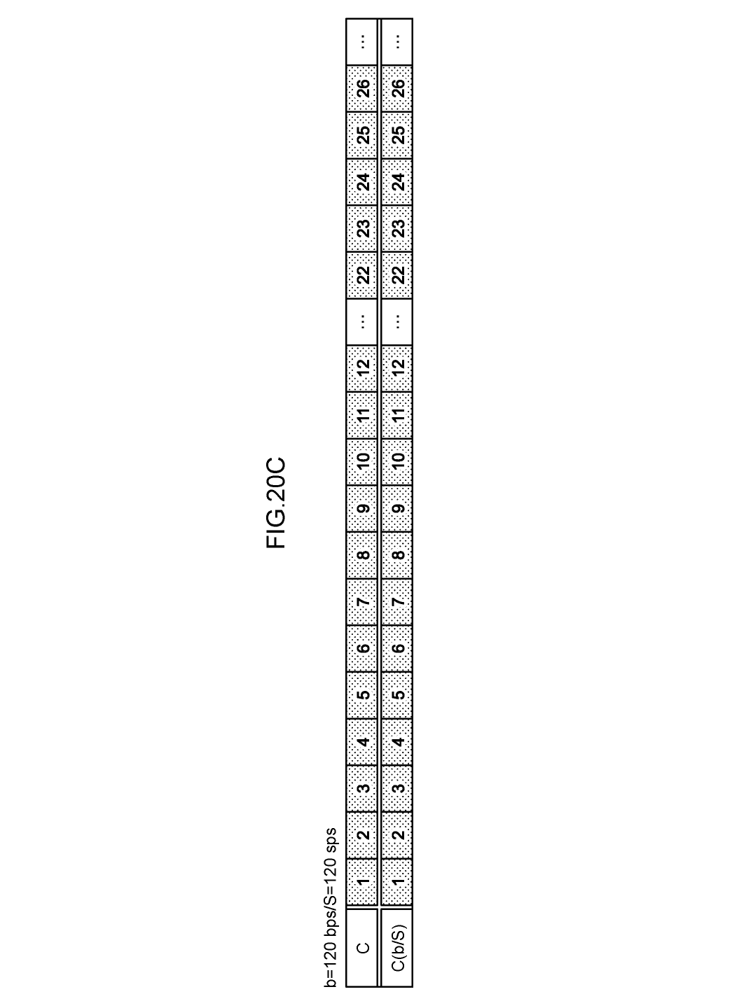

FIGS. 20A, 20B, and 20C are conceptual tables for describing light distribution control timing in the header information transmission processing. Light distribution control (step S310 or S311) in the header information transmission processing is executed at each light distribution control timing shaded in FIGS. 20A, 20B, and 20C.

In the example illustrated in FIG. 20A, the data transmission rate b is 30 bps, and the light distribution control rate S is 120 sps. In the example illustrated in FIG. 20B, the data transmission rate b is 630 bps, and the light distribution control rate S is 120 sps. In the example illustrated in FIG. 20C, the data transmission rate b is 120 bps, and the light distribution control rate S is 120 sps.

Subsequently, the processing circuit 110 determines whether the code number m has reached the number of codes M of the header code (step S312).

When the code number m is less than the number of codes M of the header code (No at step S312), the processing circuit 110 returns to the processing of step S305 and repeatedly executes the processing up to step S312.

When the code number m has reached the number of codes M of the header code (Yes at step S312), the processing circuit 110 determines whether the countdown number p has reached "1" (step S313). When the countdown number p is larger than "1" (No at step S313), the processing circuit 110 returns to the processing of step S303 and repeatedly executes the processing up to step S313.

When the countdown number p has reached "1" (Yes at step S313), the processing circuit 110 ends the header information transmission processing illustrated in FIG. 19, and returns to the information transmission processing illustrated in FIG. 17.

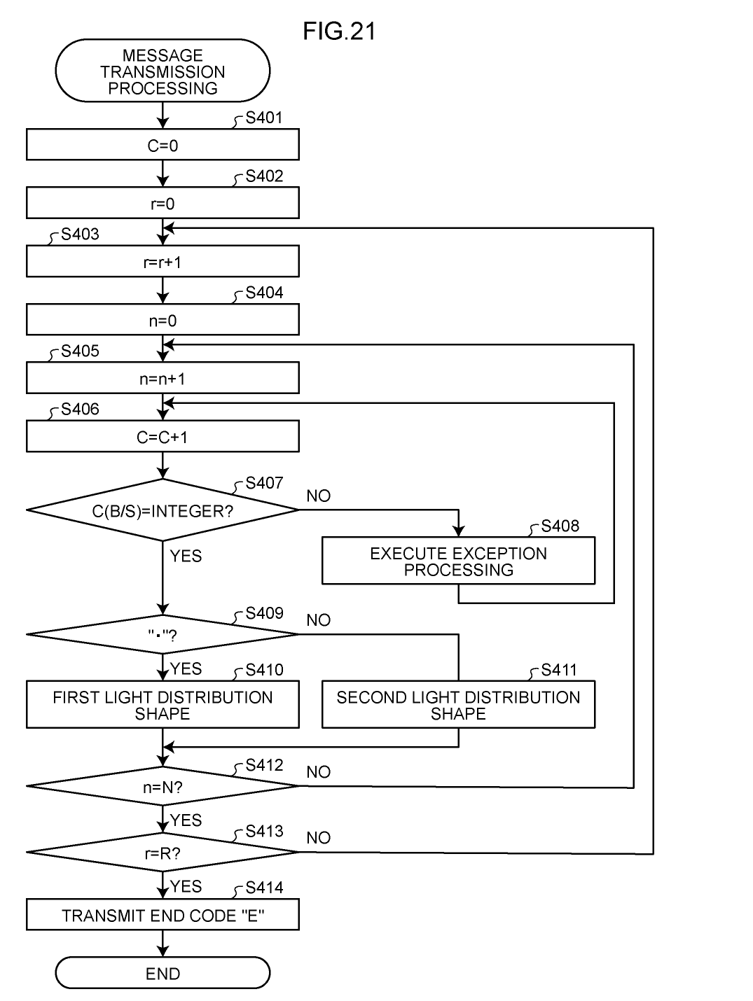

Returning to the information transmission processing illustrated in FIG. 17, the processing circuit 110 of the optical communication device 1a determines whether the message (character information) is in a Western language or a Japanese language (step S205), converts the message into Morse code (step S206), and stores the character information code converted into Morse code in the storage circuit 114. FIG. 21 is a sub flowchart illustrating an example of message transmission processing (step S207).

In the message transmission processing illustrated in FIG. 21, the processing circuit 110 first resets the light distribution control counter value C of the optical communication device 1a at the light distribution control rate S (C = 0; step S401). Then, the processing circuit 110 resets the repetition number r (r = 0; step S402), and increments the repetition number r (r = r + 1; step S403), wherein r is an integer equal to or smaller than R.

The number of codes (total number of short dot codes "·" and long dot codes "-") of the character information code is defined as N. The processing circuit 110 resets the code number n (n = 0; step S404), and increments the code number n (n = n + 1; step S405), wherein n is an integer equal to or smaller than N.

Subsequently, the processing circuit 110 increments the light distribution control counter value C (C = C + 1; step S406), and determines whether the value of C(B/S) is an integer value (step S407).

When the value of C(B/S) is not an integer value (No at step S407), the processing circuit 110 executes exception processing that is different from light distribution control in the message transmission processing (step S408). Specifically, in the exception processing, the processing circuit 110 controls the electrode drive circuit 112 to supply, to each of the drive electrodes 10 and 13 of each liquid crystal cell 2 of the optical element 100, a drive voltage with which the light distribution state of the optical element 100 becomes substantially different from the first light distribution shape and the second light distribution shape.

After executing the exception processing at step S408, the processing circuit 110 returns to the processing of step S406 and repeatedly executes the processing of step S406 to step S408.

When the value of C(B/S) is an integer value (Yes at step S407), the processing circuit 110 reads the n-th code of the character information code, and determines whether the n-th code is a short dot code "·" or a long dot code "-". Specifically, the processing circuit 110 determines whether the n-th code of the character information code is a short dot code "·" (step S409).

When the n-th code of the character information code is a short dot code "·" (Yes at step S409), the processing circuit 110 controls the electrode drive circuit 112 to supply, to each of the drive electrodes 10 and 13 of each liquid crystal cell 2 of the optical element 100, a drive voltage with which the light distribution state of the optical element 100 becomes the first light distribution shape (step S410).

When the n-th code of the character information code is a long dot code "-" (No at step S409), the processing circuit 110 controls the electrode drive circuit 112 to supply, to each of the drive electrodes 10 and 13 of each liquid crystal cell 2 of the optical element 100, a drive voltage with which the light distribution state of the optical element 100 becomes the second light distribution shape (step S411). Accordingly, the n-th code of the character information code is transmitted.

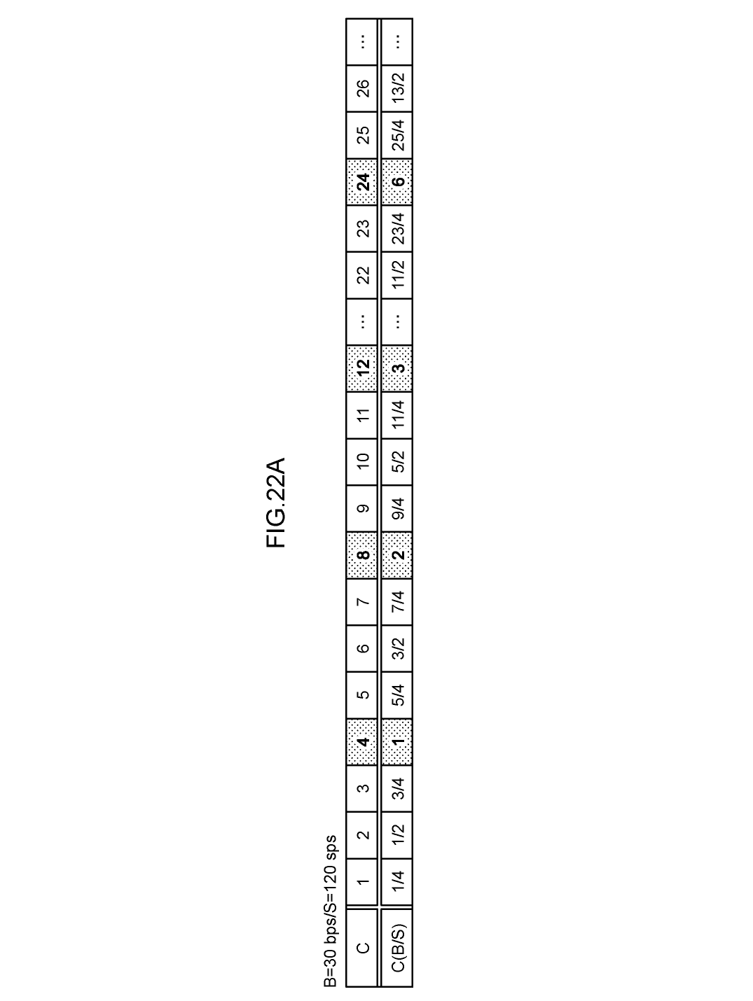

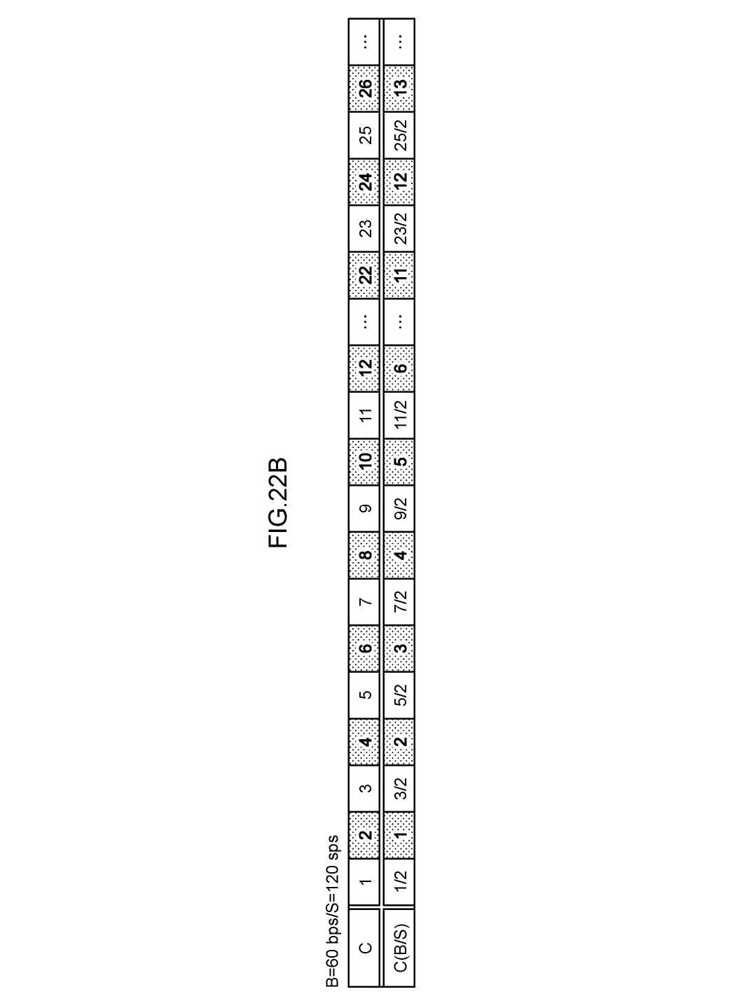

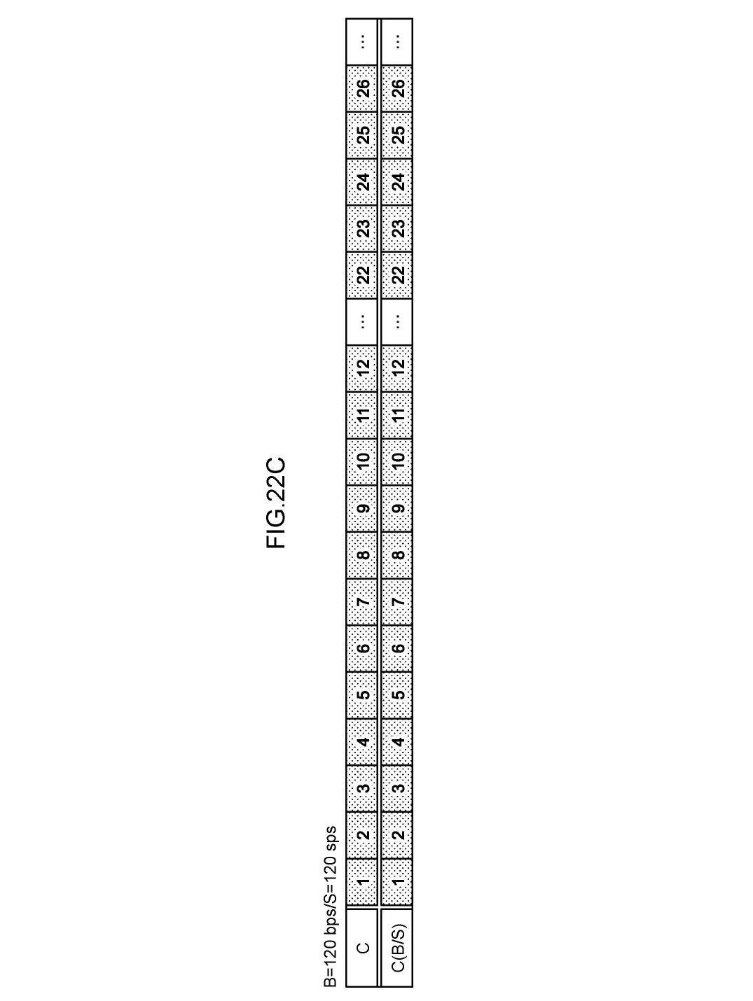

FIGS. 22A, 22B, and 22C are conceptual diagrams for describing light distribution control timing in the message transmission processing. Light distribution control (step S410 or S411) in the message transmission processing is executed at each light distribution control timing shaded in FIGS. 22A, 22B, and 22C.

In the example illustrated in FIG. 22A, the data transmission rate B is 30 bps, and the light distribution control rate S is 120 sps. In the example illustrated in FIG. 22B, the data transmission rate B is 630 bps, and the light distribution control rate S is 120 sps. In the example illustrated in FIG. 22C, the data transmission rate B is 120 bps, and the light distribution control rate S is 120 sps.

Subsequently, the processing circuit 110 determines whether the code number n has reached the number of codes N of the character information code (step S412).

When the code number n is less than the number of codes N of the character information code (No at step S412), the processing circuit 110 returns to the processing of step S405 and repeatedly executes the processing up to step S412.

When the code number n has reached the number of codes N of the character information code (Yes at step S412), the processing circuit 110 determines whether the repetition number r has reached the repetition count R of the message (step S413). When the repetition number r is less than the repetition count R of the message (No at step S413), the processing circuit 110 returns to the processing of step S403 and repeatedly executes the processing up to step S413.

When the repetition number r has reached the repetition count R (Yes at step S413), the optical communication device 1a transmits the end code "E" indicating an end position (step S414), ends the message transmission processing illustrated in FIG. 21, returns to the information transmission processing illustrated in FIG. 17, and ends the information transmission processing.

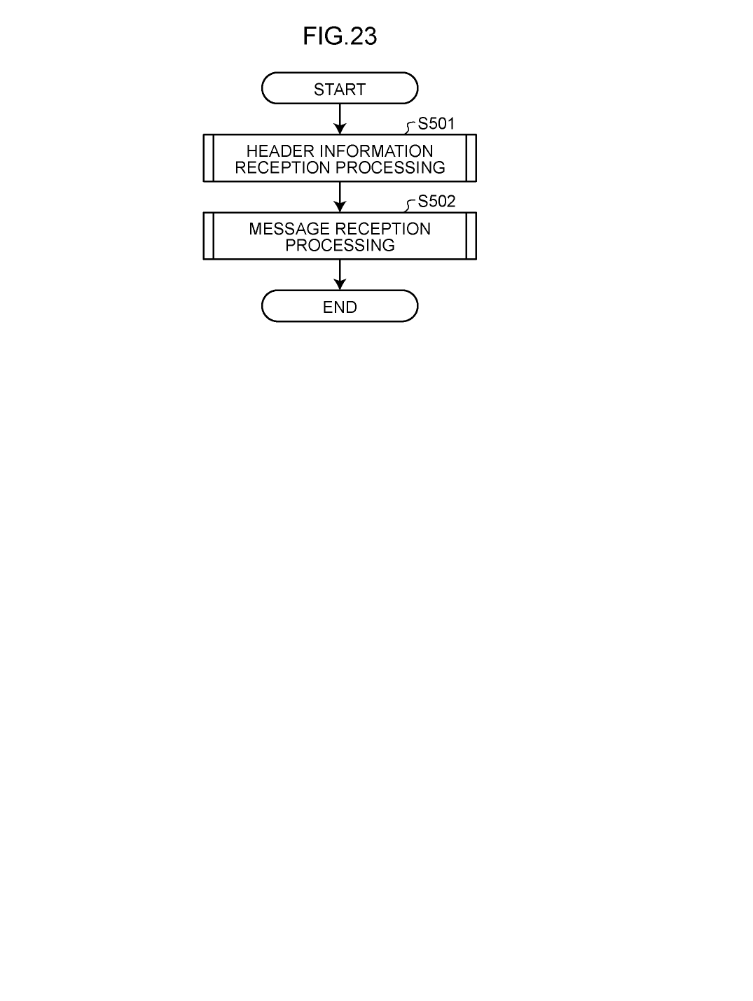

FIG. 23 is a flowchart illustrating an example of information reception processing in the reception device 400. As a precondition for the information reception processing illustrated in FIG. 23, the camera (the image capturing element 50 and the image capturing circuit 411) of the reception device 400 acquires, as image data, the light distribution state of the optical communication device 1a at a frame rate that is at least equal to or higher than the light distribution control rate of the optical communication device 1a, based on the above-described transmission protocol. The acquired image data is stored in the storage circuit 423 of the reception device 400.

Specifically, when the sampling rate of a DA converter for electrode driving in the optical communication device 1a is 120 sps, the camera (the image capturing element 50 and the image capturing circuit 411) of the reception device 400 acquires image data at a frame rate equal to or higher than 120 frames per second (fps). This can reduce omission of codes when acquiring the header code and the character information code.

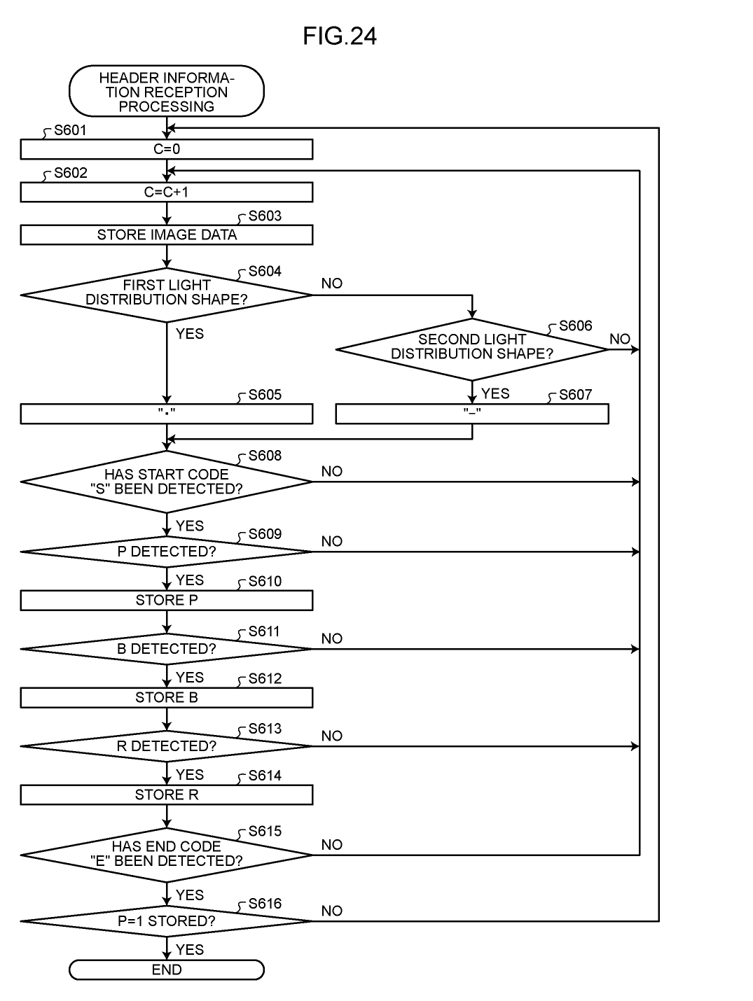

The reception device 400 first receives the header information transmitted from the optical communication device 1a based on the above-described transmission protocol (step S501). FIG. 24 is a sub flowchart illustrating an example of header information reception processing.

In the header information reception processing illustrated in FIG. 24, the processing circuit 410 of the reception device 400 first resets the counter value C corresponding to light distribution control timing of the optical communication device 1a at the light distribution control rate S (C = 0; step S601).

Subsequently, the processing circuit 410 increments the counter value C (C = C + 1; step S602) and stores, in the storage circuit 423, the image data acquired by the camera (the image capturing element 50 and the image capturing circuit 411) of the reception device 400 (step S603).

Subsequently, the processing circuit 410 analyzes the acquired image data and determines whether the light distribution state of the optical element 100 transmitted from the optical communication device 1a is the first light distribution shape (step S604). When the light distribution state is the first light distribution shape (Yes at step S604), the processing circuit 410 stores the light distribution state in the storage circuit 423 as a short dot code "·" of Morse code (step S605).

When the light distribution state is not the first light distribution shape (No at step S604), the processing circuit 410 subsequently determines whether the light distribution state is the second light distribution shape (step S606). When the light distribution state is the second light distribution shape (Yes at step S606), the processing circuit 410 stores the light distribution state in the storage circuit 423 as a long dot code "-" of Morse code (step S607).

When the light distribution state is not the second light distribution shape (No at step S606), the processing circuit 410 returns to the processing of step S602.

Through the above-described image data analysis, codes of the header code are sequentially accumulated in the storage circuit 423 of the reception device 400. The processing circuit 410 sequentially decodes the codes accumulated in the storage circuit 423 and acquires the various pieces of setting information included in the header information. A known method may be employed as an image data analytical method in the reception device 400. The present disclosure is not limited by the image data analytical method in the reception device 400.

The processing circuit 410 determines whether the start code "S" has been detected (step S608). When the start code "S" has not been detected (No at step S608), the processing circuit 410 returns to the processing of step S602.

When the start code "S" has been detected (Yes at step S608), the processing circuit 410 subsequently determines whether the header information number P has been detected (step S609). When the header information number P has not been detected (No at step S609), the processing circuit 410 returns to the processing of step S602.

When the header information number P has been detected (Yes at step S609), the processing circuit 410 stores the detected header information number P in the storage circuit 423 (step S610).

Subsequently, the processing circuit 410 determines whether the data transmission rate B of the character information code has been detected (step S611). When the data transmission rate B of the character information code has not been detected (No at step S611), the processing circuit 410 returns to the processing of step S602.

When the data transmission rate B of the character information code has been detected (Yes at step S611), the processing circuit 410 stores the detected data transmission rate B of the character information code in the storage circuit 423 (step S612).

Subsequently, the processing circuit 410 determines whether the repetition count R of the message has been detected (step S613). When the repetition count R of the message has not been detected (No at step S613), the processing circuit 410 returns to the processing of step S602.

When the repetition count R of the message has been detected (Yes at step S613), the processing circuit 410 stores the detected repetition count R of the message in the storage circuit 423 (step S614).

Subsequently, the processing circuit 410 determines whether the end code "E" indicating the end position of the character information code has been detected (step S615). When the end code "E" indicating the end position of the character information code has not been detected (No at step S615), the processing circuit 410 returns to the processing of step S602.

When the end code "E" indicating the end position of the character information code has been detected (Yes at step S615), the processing circuit 410 determines whether the header information number P = 1 is stored in the storage circuit 423 (step S616).

When the header information number P = 1 is not stored in the storage circuit 423 (No at step S616), the processing circuit 410 returns to the processing of step S601. When the header information number P = 1 is stored in the storage circuit 423 (Yes at step S616), the processing circuit 410 ends the header information reception processing illustrated in FIG. 24, and returns to the information reception processing illustrated in FIG. 23.

Through the above-described header information reception processing, the data transmission rate B of the character information code and the repetition count R of the message, which are included in the header information, are acquired. The transmission start timing of the character information code can be defined by, for example, the acquisition interval of the header information number P. Specifically, for example, a position obtained by adding the acquisition interval of the header information number P to the acquisition timing of the header information number P = 1 may be acquired as the transmission start timing of the character information code. Accordingly, the processing circuit 410 of the reception device 400 can acquire the transmission start timing of the character information code by analyzing the header information acquired by the above-described header information reception processing.

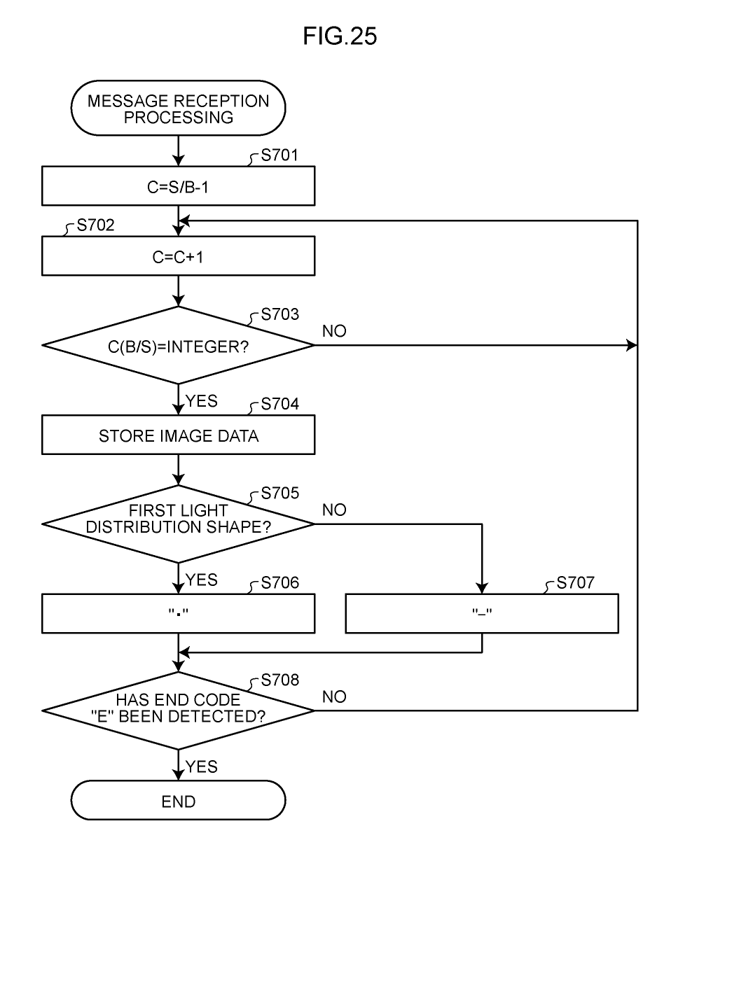

Returning back to the information reception processing illustrated in FIG. 23, the processing circuit 410 receives the message transmitted from the optical communication device 1a based on the various pieces of setting information acquired by the above-described header information reception processing (step S502). FIG. 25 is a sub flowchart illustrating an example of message reception processing.

In the message reception processing illustrated in FIG. 25, at the transmission start timing of the character information code acquired by the above-described header information reception processing, the processing circuit 410 of the reception device 400 resets the counter value C corresponding to light distribution control timing of the optical communication device 1a at the light distribution control rate S (C = S/B -1; step S701). For example, the value of C = S/B-1 is "3" when the data transmission rate B of the character information code is 30 bps.

Subsequently, the processing circuit 410 increments the counter value C (C = C + 1; step S702), and determines whether the value of C(B/S) is an integer value (step S703). For example, when the data transmission rate B is 30 bps, the counter value C becomes "4" at initial step S702 and the value of C(B/S) becomes "1" at subsequent step S703.

When the value of C(B/S) is not an integer value (No at step S703), the processing circuit 410 returns to the processing of step S702.

When the value of C(B/S) is an integer value (Yes at step S703), the processing circuit 410 stores, in the storage circuit 423, the image data acquired by the camera (the image capturing element 50 and the image capturing circuit 411) of the reception device 400 (step S704).

Subsequently, the processing circuit 410 analyzes the acquired image data and determines whether the light distribution state of the optical element 100 transmitted from the optical communication device 1a is the first light distribution shape or the second light distribution shape. Specifically, the processing circuit 410 determines whether the light distribution state of the optical element 100 transmitted from the optical communication device 1a is the first light distribution shape (step S705).

When the light distribution state is the first light distribution shape (Yes at step S705), the processing circuit 410 stores the light distribution state in the storage circuit 423 as a short dot code "·" in Morse code (step S706). When the light distribution state is the second light distribution shape (No at step S705), the processing circuit 410 stores the light distribution state in the storage circuit 423 as a long dot code "-" in Morse code (step S707).

Subsequently, the processing circuit 410 determines whether the end code "E" indicating the end position of the character information code has been detected (step S708). When the end code "E" indicating the end position of the character information code has not been detected (No at step S708), the processing circuit 410 returns to the processing of step S702. Subsequently, codes of the character information code are sequentially acquired at timing when the value of C(B/S) becomes an integer value at step S703.

When the end code "E" indicating the end position of the character information code has been detected (Yes at step S708), the processing circuit 410 ends the message reception processing illustrated in FIG. 25, returns to the information reception processing illustrated in FIG. 23, and ends the information reception processing.

In the optical communication system 200a according to the second embodiment described above, the reception device 400 has a function of decoding Morse code transmitted from the optical communication device 1a. Accordingly, high-speed information transmission is possible.

The header information is transmitted at the data transmission rate b (second data transmission rate) defined in advance between the optical communication device 1a and the reception device 400, and the character information code is transmitted at the data transmission rate B (first data transmission rate) included in the header information. Then, the reception device 400 can acquire the transmission start timing of the character information code by analyzing the header information.

Each of the above-described embodiments provides an optical communication device and an optical communication system that can shorten the transmission time of Morse-encoded information.

The preferable embodiments of the present disclosure are described above, but the present disclosure is not limited to the embodiments. Contents disclosed in the embodiments are merely exemplary and may be modified in various kinds of manners without departing from the scope of the present disclosure. For example, in a case where an optical communication device of the present disclosure is capable of adjusting not only the light distribution shape but also brightness and light color, the configuration of the present disclosure may be used to adjust the brightness and light color. Appropriate modifications made without departing from the scope of the present disclosure naturally belong to the technical scope of the present disclosure.

What is claimed is:

1. An optical communication device comprising:
a light source;
an optical element provided on an optical axis of the light source and configured to control a light distribution state of light emitted from the light source; and
a processing circuit configured to perform light distribution control of the optical element, wherein
the processing circuit is configured to
generate a character information code obtained by converting character information into Morse code,
control the light distribution state of the optical element to a first light distribution shape when transmitting a short dot code of the character information code, and
control the light distribution state of the optical element to a second light distribution shape different from the first light distribution shape when transmitting a long dot code of the character information code.

2. An optical communication system comprising:
an optical communication device; and
a control device configured to transmit character information to the optical communication device, wherein
the optical communication device includes
a light source,
an optical element provided on an optical axis of the light source and configured to control a light distribution state of light emitted from the light source, and
a processing circuit configured to perform light distribution control of the optical element, and
the processing circuit is configured to
generate a character information code obtained by converting character information into Morse code,
control the light distribution state of the optical element to a first light distribution shape when transmitting a short dot code of the character information code, and
control the light distribution state of the optical element to a second light distribution shape different from the first light distribution shape when transmitting a long dot code of the character information code.

3. The optical communication system according to claim 2, wherein the control device is configured to transmit, to the optical communication device, setting information for transmitting the character information code.

4. The optical communication system according to claim 3, wherein
the setting information includes at least a first data transmission rate for transmitting the character information code, and
the processing circuit is configured to control the light distribution state of the optical element at the first data transmission rate when transmitting the character information code.

5. The optical communication system according to claim 4, further comprising a reception device configured to decode Morse code transmitted from the optical communication device.

6. The optical communication system according to claim 5, wherein
a second data transmission rate for transmitting header information including at least the setting information is defined between the optical communication device and the reception device, and
the processing circuit is configured to control the light distribution state of the optical element at the second data transmission rate when transmitting the header information.

7. The optical communication system according to claim 6, wherein the reception device is configured to acquire a transmission start timing of the character information code based on the header information.
